(19) United States
(12) Patent Application Publication
(10) Pub. No.: US 2003/0001903 A1
(43) Pub. Date: Jan. 2, 2003

(54) Software-based system for educational tools

(76) Inventor: Michael Duffy, Honeoye Falls, NY (US)

Correspondence Address: GREENWALD & BASCH, LLP, 349 WEST COMMERCIAL STREET, SUITE 2490, EAST ROCHESTER, NY, 14445, US

(21) Appl. No.: 10/165,434

(22) Filed: Jun. 7, 2002

Related U.S. Application Data
(60) Provisional application No. 60/297,110, filed on Jun. 8, 2001.

(51) Int. Cl. G09G 5/00

(52) U.S. Cl. 345/810

(57) ABSTRACT

The present invention is a method and apparatus for the development and implementation of complex educational and training software systems. The system employs a macromedia software engine that, using a tag-based text document as an input, is capable of creating customizable macromedia output for display via a computer and through a network.

### CROSS REFERENCE

The following related application is hereby incorporated by reference for its teachings:

“SOFTWARE-BASED SYSTEM FOR EDUCATIONAL TOOLS,” Michael Duffy, application No. 60/297,110, filed Month Jun. 8, 2001.

This invention relates generally to a software development system, and more particularly to a system that may be employed to develop, with a word-processor interface, complex educational and training software for direct use by consumers.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### BACKGROUND AND SUMMARY OF THE INVENTION

In the United States, bicycling is one of the most popular recreational activities. Of the forty three million Americans who ride bicycles, twenty four million are mountain bicyclists to whom one embodiment of the present invention is directed. What started in the late 1970's as a pursuit of fun and thrills down the California mountains on garage retrofitted single speed bicycles has evolved into a multi-billion dollar industry. Cycling, and more particularly mountain bicycling, was finally recognized with its introduction as an Olympic sport at the 1996 Atlanta summer games. It has since become an American pastime for people of all ages.

The modern mountain bicycle is a light, strong and highly complex machine requiring a knowledgeable mechanic for everyday maintenance and replacement of damaged components. Historically, a professional mechanic has performed all bicycle maintenance at bicycle shops. Today, however, many of these shops can no longer afford the wages of a professional mechanic and have replaced them with lower wage individuals having little or no training.

The maintenance situation prevailing at bicycle shops today has precipitated a significant trend toward bicycle repair by the bicycle owner. Aspects of the present invention are intended to meet the product maintenance requirements of bicycle technicians, mountain bicycle owners and casual riders as well. Accordingly, some of the issues/opportunities being addressed by the present invention are:

1. Repair books that are obsolete, difficult to understand and use and are easily damaged.

2. The increasing cost of maintenance at bicycle shops.

3. The decreasing quality of maintenance at bicycle shops.

4. The increasing length of time required to effect maintenance performed at bicycle shops.

The present invention is directed to software technology and its use as an educational and training aide or resource. As described herein, one embodiment of the present invention is directed to instruction and teaching of bicycle maintenance. It will be appreciated, however, that the techniques described relative to the software-based system for educational tools may be applied to other instructional and educational settings, including sales and marketing training, equipment servicing and equipment service technician training (e.g., automotive, office equipment, home appliances, military equipment), user “manuals,” etc.

Heretofore, various “automated” training systems have attempted to use a software user interface to enhance the educational or training experience of users. The present invention eliminates or reduces problems with known educational resources using a core software technology that changes how instruction based programs teach, are utilized, and more importantly how they are assembled. Applications authored with the present invention are generally based on proven visual and cognitive learning models that incorporate animation, audio, graphics, pictures, video and text to instruct, enabling a user to choose or utilize the learning method most comfortable to them. Furthermore, the interface currently employed and contemplated for the present system enables those having only limited “programming” skills to develop and use complex, computer-based educational tools.

Using the present invention, educational and training software applications may be written from the core educational resources and content available for many products and activities, such as: maintenance of athletic equipment such as bicycles; off-road and aquatic vehicles (snowmobiles, motorcycles, jet-skis); techniques for ski-tuning and fly fishing; dog-training; CPR; home repairs; training for computer controlled equipment operators; and outside service technicians such as those from distributors and manufacturers. It is also intended that the present invention may be employed to create digital media based user or operator manuals, thereby making critical updates as easy as burning a new master of the media.

The embodiment described herein details aspects of the present invention in accordance with a mountain bicycle maintenance/training system, albeit the various aspects of the invention are not intended to be limited to such an embodiment. The maintenance and training system is a suitable resource for not only the mountain biking enthusiast who will experience complex maintenance situations, but also the casual cyclist who only requires general and preventative maintenance instruction and bicycle fitting techniques. The software offers a step-by-step solution to maintenance situations, where access to information may be accomplished via graphical menus related to the subject of interest. The software also allows the user to view and/or print only those instructions of interest. Users of the software will experience cost-effective, time-saving media that is both interactive and easy to understand.

The software features examples of maintenance work being performed on bicycle components where the components are from selected major component manufacturers. In one embodiment, the manufacturers whose components are depicted may have provided equipment or paid the Company a sponsorship fee to be featured in the software version. Due to the ease of modifying the software with the software engine, it is possible to create manufacturer or bicycle-specific training software where, for example, a bicycle that the owner has just purchased is depicted, with all of the component parts. Hence, all major brand bicycles may be maintained using the software, and the software depicts the user's bicycle model. This is possible because the product instruction is a methodology that can be adapted to all service and maintenance situations.

The bicycle maintenance and training system features a navigational structure beginning with a graphical main menu that utilizes an image of the item being maintained as the basis for the menu. For example, in the case of a bicycle maintenance software tool, the main menu includes a bicycle and offers the user the selection of particular component modules such as: Drivetrain; Frame; Wheels; Suspension; Cockpit; Brakes; and Bicycle Fit modules. Selection of a module is accomplished by a user rolling a mouse to drive a cursor over the module of interest, where the software enhances the module upon sensing the cursor, and selecting the module. These modules are further exploded into their core components, where each module features tool requirements, installation, removal, adjustment, maintenance/lubrication, technical, trail repair and problems and solutions sections. Thus, a user can access information at any level.

In accordance with the present invention, there is provided a computer-based bicycle maintenance resource, including: a computer running a macromedia software program (Macromedia Director player) for dynamically creating a plurality of interrelated scenes for display; a user-interface for displaying said scenes, wherein a plurality of the scenes represent hierarchical menu screens and where a main menu screen utilizes an image of a bicycle for the selection of menu items by a user rolling over the item and selecting the item; and a user input device, where the user's selection of an item with the user input device will result in the display of the selected one of a plurality of modules and any components therein.

In accordance with another aspect of the present invention, there is provided a computer-based training resource, including: a computer running a macromedia software program for dynamically creating a plurality of scenes for display; a user-interface for displaying said scenes, wherein a plurality of the scenes represent a plurality of menu screens and where a main menu screen utilizes an image of an apparatus to which the training is directed and lower level menu screens depict particular components or portions thereof; and a database of images of various components of the apparatus, wherein each of said images includes an identifier of the component manufacturer, wherein the images of components of at least one manufacturer may be inserted into the user-interface in response to the manufacturer's agreement to pay compensation for such “advertisement.”

In accordance with yet another aspect of the present invention, there is provided a computer-based training resource, including: a computer running a macromedia software program for dynamically creating a plurality of scenes for display; and a cache, associated with said computer, said cache comprising a look-ahead module, wherein loading of each linked element of a current display into the cache is initiated by the current display prior to a user selection, thereby improving the performance of the macromedia software.

In accordance with yet a further aspect of the present invention, there is provided a computer-based media development resource, including: a computer running a macromedia software program for dynamically creating a plurality of scenes for display; a user-interface for displaying said scenes, wherein a plurality of the scenes represent a plurality of menu screens and where a main menu screen utilizes an image with which the resource is related, and lower level menu screens depict particular components or portions of said image; and a database of sub-images, each depicting elements of the image, wherein each of said sub-images includes a unique identifier to control its insertion into the user-interface.

In accordance with yet another aspect of the present invention, there is provided a method for the dynamic display of computer-generated media, including the steps of: creating a text-based document to direct the display of the computer-generated media; parsing the text-based document to determine relationships between elements of the computer-generated media; a computer running a macromedia software program for dynamically creating a plurality of scenes for display; a user-interface for displaying said scenes, wherein a plurality of the scenes represent a plurality of menu screens and where a main menu screen utilizes an image with which the resource is related, and lower level menu screens depict particular components or portions of said image; and a database of sub-images, each depicting elements of the image, wherein each of said sub-images includes a unique identifier to control its insertion into the user-interface.

One aspect of the invention deals with a basic problem in training and educational materials, and the limited manner in which document-based resources may be developed and used. This aspect is further based on the discovery of a technique that alleviates this problem. The technique utilizes a custom software engine that is designed to take, as an input, a word-processing document in a native format (e.g., MS-Word or extensible markup language (XML)). The word processing document is used to drive the creation of one or more “scenes” or screens of a user-interface that depicts or displays the training or educational content.

The technique described above is advantageous because it is inexpensive compared to other approaches for the development of training and educational content, thereby allowing the development to be completed by trainers and educators without the aid of others (e.g., graphic designers, etc.) In addition, the techniques described herein can be used to quickly develop training materials from pre-existing documents. The techniques of the invention are advantageous because they provide a range of alternatives, each of which is useful in appropriate situations.

### BRIEF DESCRIPTION OF THE DRAWINGS

FIG. 1 is a schematic block diagram of a preferred embodiment for implementing aspects of the present invention;

FIGS. 2 and 3 show sequential scenes or pages of an interactive bicycle maintenance system produced in accordance with the present invention;

FIG. 4 is an exemplary embodiment for use of a program created by the system of FIG. 1;

FIG. 5 is a generalized flowchart illustrating the hierarchical “menu” process carried out in accordance with an aspect of the present invention;

FIGS. 6-9 and 10 are exemplary scenes from a display in accordance with the present invention;

FIG. 11 is a representative computer screen depicting a native word processor operating on a text-based document in accordance with an aspect of the present invention;

FIGS. 12, 13-14, 15-17, 18 and 19 are exemplary scenes from a display in accordance with the present invention;

FIG. 20 is another representative computer screen depicting a native word processor operating on a text-based document in accordance with an aspect of the present invention;

FIG. 21 is an exemplary scene from the display in accordance with another aspect of the present invention; and

FIG. 22 is an alternative embodiment of the present invention where the output program further includes look-ahead caching features to facilitate rapid changing of scenes on the display.

The present invention will be described in connection with a preferred embodiment, however, it will be understood that there is no intent to limit the invention to the embodiment described. On the contrary, the intent is to cover all alternatives, modifications, and equivalents as may be included within the spirit and scope of the invention as defined by the appended claims.

### DESCRIPTION OF THE PREFERRED EMBODIMENT

For a general understanding of the present invention, reference is made to the drawings. In the drawings, like reference numerals have been used throughout to designate identical elements. In describing the present invention, the following term(s) have been used in the description.

“User input circuitry” is circuitry for providing signals based on actions of a user. User input circuitry can receive signals from one or more “user input devices” that provide signals based on actions of a user, such as a keyboard or a mouse. The set of signals provided by user input circuitry can therefore include data indicating mouse operation and data indicating keyboard operation. Signals from user input circuitry may include a “request” for an operation, in which case a system may perform the requested operation in response.

A “display” is an image output device that provides information in a visible form. A display may, for example, include a cathode ray tube; an array of light emitting, reflecting, or absorbing elements; a structure that presents marks on paper or another medium; or any other structure capable of defining an image in a visible form. To “present an image” on a display is to operate the display so that a viewer can perceive the image.

A wide variety of display techniques for data processing systems are available including, for example, various graphical user interfaces, but, despite their diversity, these techniques tend to have certain common characteristics. One fundamental common characteristic is that a display produces human perceptions. In this application, the term “display feature” refers to any human perception produced by a display.

A “display object” or “object” is a display feature that is perceptible as a coherent unity. An “object surface” or “surface” is a display feature that is perceptible as a surface of a display object; for example, the outer boundary of a three-dimensional display object is a surface. A “region” on a display is an area of the display or scene. A “shape” is a display object that has a distinguishable outline; for example, a circular display object is a shape.

An image “includes” an object if presentation of the image can produce perception of the object. A signal from a user input device “indicates” a region of a surface if the signal includes data from which the region can be identified. A “structure” is a display feature that includes other display features within it, all of which appear to be connected into a unity.

A common characteristic of display systems is a mapping between items of data within the system and display features presented by the system. A structure “represents” a body of data when display features of the structure map one-to-one with the items of data in the body of data. A display feature “represents” the item of data to which it maps. For example, each node of a hierarchical node-link structure could represent a node in a tree of data or in another hierarchy of data items such as a directed graph that is organized into levels. The links of the structure can represent relationships between items of data, so that the links in a hierarchical node-link structure can represent hierarchical relationships such as parent-child relationships.

A “three-dimensional structure” is a structure that is perceived as extending in three orthogonal dimensions. Typically, a display will have a two-dimensional display surface. In the present invention the perception of a third dimension is produced with visual cues in response to a “roll-over”—where user input circuitry is employed to move a displayed cursor over a portion of the display and while doing so, that portion of the display image is brought to the foreground for ease of selection and a surrounding image(s) is depicted as background (washed-out mode). Alternative methods of depicting rollover include obscuring of distant objects by near objects, size changes in objects that change distance as in perspective drawing, and different shading of objects at different distances.

A “scene” is a series of one or more images that can be presented by a sequence of animation cycles such that display features appear to continue through the scene. Data “defines” a scene when it can be used to produce data defining an image(s) of the scene.

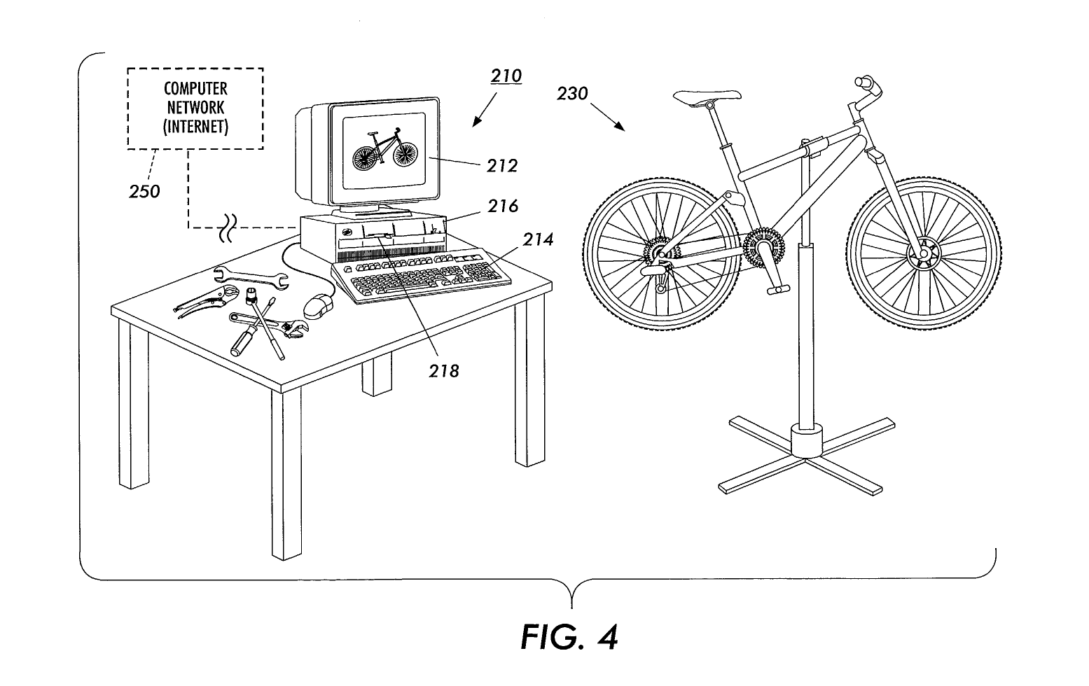

A “selectable unit” is a display feature that is perceived as a bounded display area that can be selected, for example, “Exit” element 420 in FIG. 4A. The term “select,” when used in relation to a selectable unit, means a user input operation that includes a signal that uniquely indicates the selectable unit. In general, an action by a user “indicates” a thing, an event, or a characteristic when the action demonstrates or points out the thing, event or characteristic in a manner that is distinguishable from actions that do not indicate the thing, event, or characteristic. The user can, for example, use a pointing device such as a mouse to select a selectable unit by indicating its position and clicking a button on the pointing device.

Various aspects of the present invention are described and depicted in a format suitable for use with a multi-media composition system. An example of certain aspects of the present invention is found in the software program titled Breakit, Fixit, Ridelt, (Version 1.1; Copyright 2001), distributed by Break It, Fix It, Ride It, Inc. of Rochester, N.Y., the details of which are hereby incorporated by reference. Furthermore, for ease of development, some aspects of the present invention may preferably be implemented using multi-media composition systems such as Macromedia's Director series of software programs. Although such aspects are described in accordance with the Director software, it is contemplated that some or all of the functionality provided by Director may be provided by alternative software programs—including independently created software.

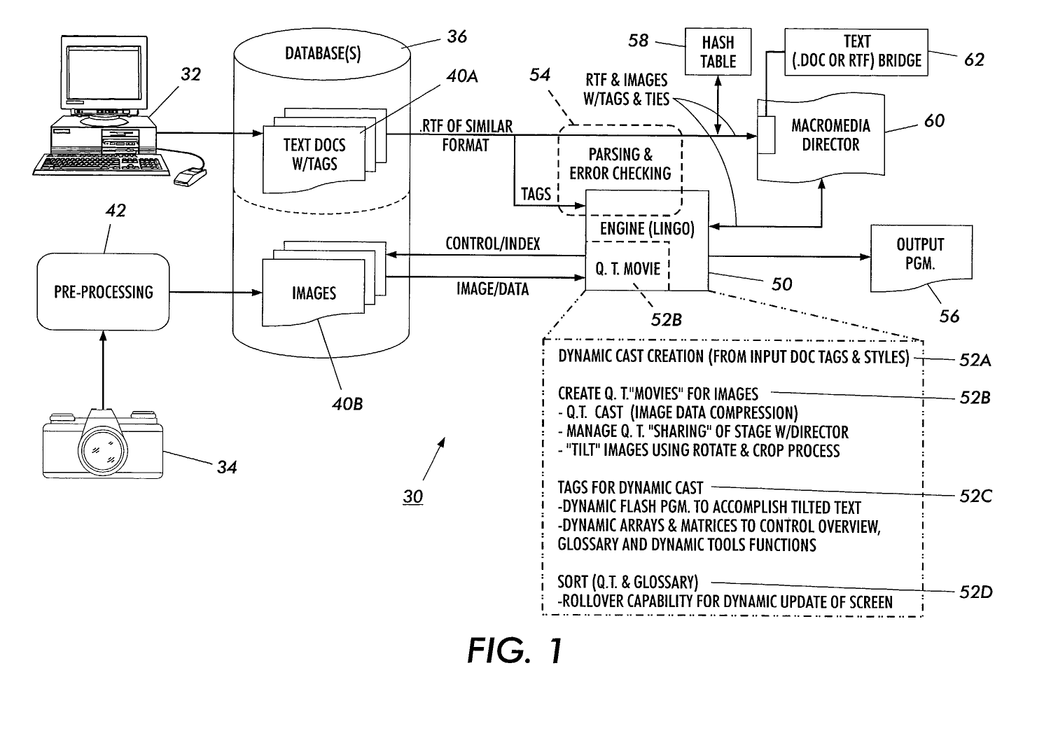

Turning now to FIG. 1, there is depicted a block diagram representing various upper-level elements of a system 30 suitable for carrying out aspects of the present invention. System 30 is a design or development embodiment for the present invention and preferably includes a plurality of network-based workstations 32 (for software development, image editing, etc.) digital cameras or other image capture equipment 34, and at least one hard disk or similar storage technology 36 a portion of which is used for storage of a database.

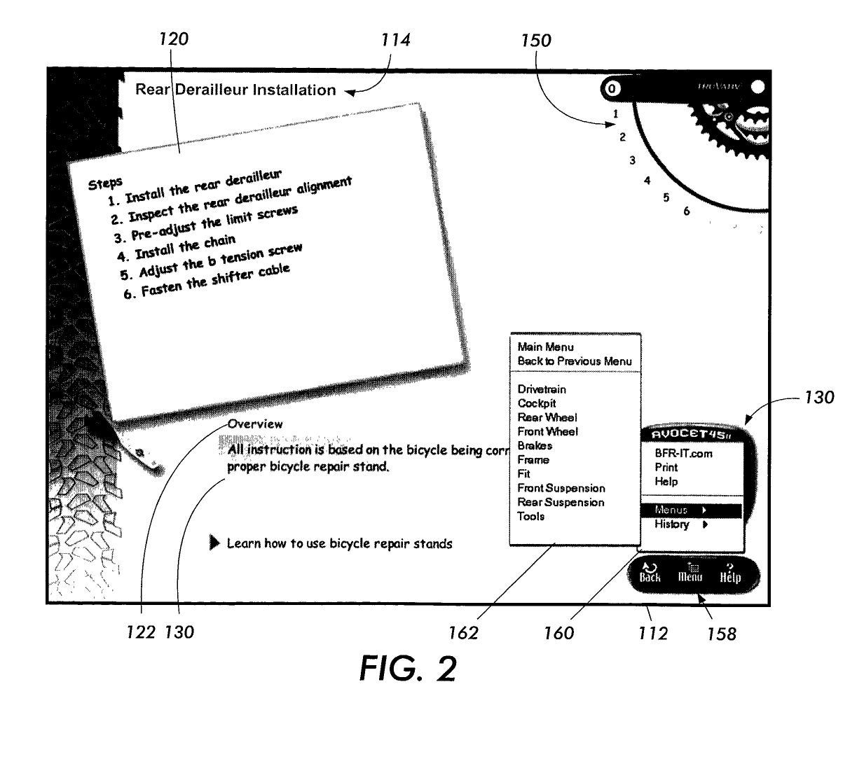

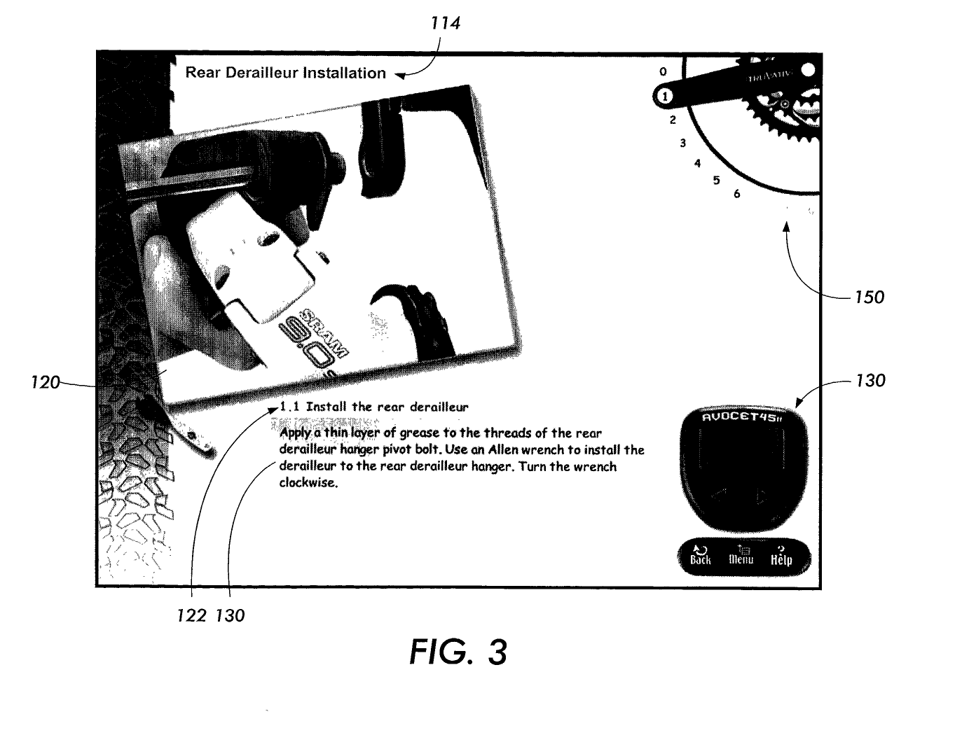

In one embodiment, storage device 36, in conjunction with a server (not shown) or a workstation 32, may operate database software such as that provided by Oracle Corporation, to provide one or more document and image databases 40A, 40B, respectively. System 30 utilizes one or more workstations to create text-based documents using native word processing software such as Microsoft Word (e.g., Microsoft Word 2000), where the output document(s) are saved in a rich-text format (.rtf) so as to preserve text formatting and tags in a common format. As will be described below, it is the textual information, in conjunction with the tags that form the basis for the improved development method enabled by this invention. Moreover, it will be appreciated that other tag-capable file types may be used—including extensible markup language (XML) files. The formatting of such text-based documents is directly interpreted by the system as the hierarchical relationship among different scenes or display screens that are part of output program 56 that is ultimately created by the system. Examples of the scenes 112 displayed by the system are found in FIGS. 2 and 3, where each of the scenes may employ a common layout having a title block 114, a tilted image region 120, a text topic block 122 and associated text instruction block 130. Also included are links 140 and a navigational aid 130. It will be appreciated that additional graphical information, such as the crank set 150 in the upper-right corner may be used for purposes of advertising and as a navigational aid—where the position of the crank indicates a user's traversal through the current topic (e.g., Rear Derailleur Installation). Also depicted in FIG. 2 is a feature, as will be described in more detail below, that facilitates a user's navigation through the system via menus or the user's history of the pages that have been visited, or the point where the user left during last use.

Cameras 34 or similar image input means initially capture images employed in the creation of the output program, in accordance with the present invention. The images are then stored in the database 40B. The images may also be processed to modify the image content before or after being stored, as indicated by pre-processor 42. Processing may include image enhancement, color adjustment, cropping, rotating and other well-known image processing techniques and functions. It is also contemplated that the images may be post-processed, to not only alter the image content, but also to add tags or other identification information to the images, and to complete any cropping, rotation or other image processing as described in further detail below.

As used herein, the content of the databases 40A and 40B is input to a software engine 50 that is the core of the system 30. Engine 50, a software program itself, operates in accordance with a set of pre-programmed instructions to dynamically create an output program 56 that may then be loaded and operated on a user's workstation, via an internet browser, or in any number of user-viewable devices. More specifically, engine 50 includes various functions that enable the database input information (40A and 40B) to be compiled into the output program 56.

The formation of the output program is, in accordance with an aspect of the present invention, largely controlled by the formatting of the text-based documents stored in database 40A. Accordingly, engine 50 may include a parsing and error checking function 54, wherein a text-based document (with .rtf or similar tags) is read and checked for consistency and errors. The text-based document, once checked, is then employed by the engine 50 and is also used as a direct input into the multi-media software system 60 by Macromedia, called Director™ using a “bridge” 62 available in older versions of Director (e.g., Version 6.5). Alternatively, the requirement for the bridge feature of Director 6.5 may be eliminated by creating an extra for the .rtf processing program. It will be appreciated that aspects of the present invention are written to operate in association with Director, and therefore may be implemented using Director's native software language “Lingo.” Alternatively, it is contemplated that engine 50 may operate with similar or alternative multi-media development software, or that the engine itself may create data that is directly viewable with known multi-media viewers.

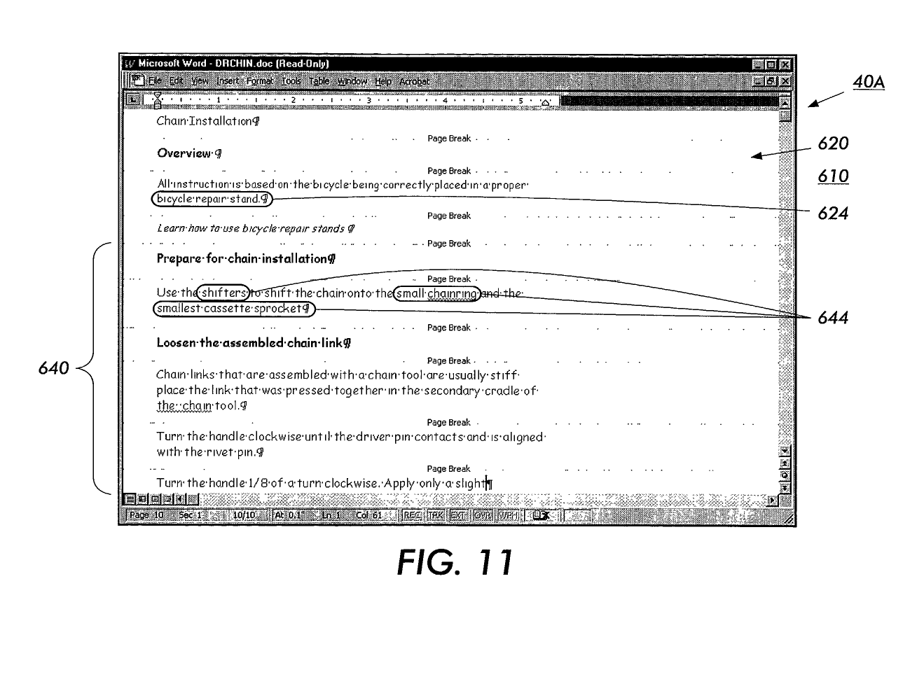

A word processor such as MS-Word, using RTF output format, is one way to bring in formatted text (text styles based upon a template) and to do it quickly. The present invention, through engine 50, uses a Word document that has instruction imbedded within the text-based documents to create dynamic casts for the universal Macromedia media player. It is further contemplated that the text-based inputs may also be implemented in the form of Java and extensible markup language (XML) tagged documents, in which case a Java XML parse engine would parse the text-based document into the Oracle database. An example of a parsed and corrected document is depicted in window 610 of FIG. 11. Within the engine, there are constraints also that determine whether the text-based document being passed in has been formatted correctly. If not, the parsing function 54 will flag the document and a “programmer” will receive an error message indicating what the problem is (not shown). As will be further described below, the tagged text-based document (file) serves as the structure by which the particular elements of any scene, or associated navigational features, are represented.

In accordance with the requirements of Director, in one embodiment of the present invention, engine 50 dynamically creates cast members from the tags in the text-based document(s) of database 40A. The tags are the styles, and in a native word processing environment the styles are actually visual basic tags. With respect to the text-based documents, one of the functions accomplished by engine 50 (as depicted in the lower right corner of FIG. 1) is that it reads the tags and then creates the various cast members dynamically (52A). Engine 50 creates what could be referred to as navigational cast members (controlling user-selectable features of a scene that is displayed), as well as stage cast members (viewable features and objects of a displayed scene). The output of Director is then “shared” with engine 50, so as to utilize Director's embedded scene development functionality. It will also be appreciated that additional features and functionality not available in Director, are implemented via engine 50.

The navigational cast members are part of the step-by-step control or sequencing of scenes in the output multi-media program 56. A stage cast member, on the other hand, is a text block, although some of the text blocks may themselves be dynamic links. Such blocks, referred to as “go-to's”, indicate exactly where to take the scene, so that the link may take you back to a prior view or scene or, in the case of a step-by-step procedure being displayed, the link may take the user to a certain step in the procedure or to a completely new procedure. In a preferred embodiment, the coordination and control of the features of such go-to's blocks is done automatically through engine 50. In other words, the navigation options are handled in response to the style/characteristics of the text in the document.

More specifically, as the engine starts to parse the text-based document, for example a document such as DRRDIN.dat (Rear Derailleur Installation) for which an example is included below, it begins creating the cast members.:

{\rtf1\mac\ansicpg10000\uc1
\deff20\deflang1033\deflangfe1033{\upr{\fonttbl{\f0\fnil\fcharset256\fprq2{\*\panose

| | |
|---|---|
| 00020206030504050203}Times New Roman{\*\falt times | New |

Roman};}{\f20\fnil\fcharset256\fprq2{\*\panose 00030f07020303020202}Comic Sans MS;}

| | |
|---|---|
| }{\*\ud{\fonttbl{\f0\fnil\fcharset256\fprq2{\*\panose 00020206030504050203}Times | New |
| Roman{\*\falt Times New Roman};}{\f20\fnil\fcharset256\fprq2{\*\panose | |

| | |
|---|---|
| 00030f07020303020202}Comic | Sans |

MS;}}}}{\colortbl;\red0\green0\blue0;\red0\green0\blue255;
\red0\green255\blue255;\red0\green255\blue0;\red255\green0\blue255;\red255\green0\blue0;\
\red0\green255\blue255;\red0\green255\blue0;\red255\green0\blue255;\red255\green0\blue0;\red255\
green255\blue0;\red255\green255\blue255;\red0\green0\blue128;\red0\green128\blue128;
\red0\green128\blue0;\red128\green0\blue128;\red128\green0\blue0;\red128\green128\
blue0;\red128\green128\blue128;\red192\green192\blue192;}{\stylesheet{\n
nowidctlpar\faauto\adjustright\rin0\lin0\itap0 \f20\fs28\lang1033\cgrid \snext0 Normal;}{\*\cs10
\additive Default Paragraph Font;}{\*\cs15\additive \fs16
\sbasedon10 annotation reference;}{\s16\nowidctlpar\faauto\adjustright\rin0\lin0\itap0

| | |
|---|---|
| \f20\fs20\lang1033\cgrid \sabsedon0 \snext16 | annotation |

text;}{\s17\sa60\nowidctlpar\faauto\adjustright\rin0\li0\itap0\i\f20\lang10933\cgrid
\sbasedon0 \snext17 \sautoupd Go To;}{\s18\sa40\nowidctlpar\faauto\adjustright\rin0\lin0\itap0

| | |
|---|---|
| \b\f20\fs28\lang1033\cgrid \sbasedon0 \snext18 \sautoupd | Step |

Heading;}{\s19\sa20\nowidctlpar\faauto\adjustright\rin0\lin0\itap0 \f20\fs28\cf1\lang1033\cgrid
\sbasedon18 \snext 19 \sautoupd Text Block Normal;}}{\info{\title REAR DERAILLEUR

| | |
|---|---|
| INSTALL}{\author Harve}{\operator | Jim |

Gay}{\creatim\yr2001\mo3\dy21\hr14\min44;56 {\revtim\yr2001\mo6\dy20\min1}{\version29}{\edmins
92}{\nofpages49}{\nofwords815}{\nofchars4646}
{\*\company
SMP}{\nofcharsws5705}{\vern8243}}\ftnbj\aenddoc\noxlattoyen\expshrtn\noultrlspc\dntblnsbdb\
nospaceforul\hyphcaps0\formshade\horzdoc\dgmargin\dghspace120\dgvspace120\dghorigin1
701\dgvorigin1984\dghshow0\dgvshow3

| | |
|---|---|
| \jcompress\viewkind4\viewscale100\pgbrdrhead\pgbrdffoot\nolnhtadjtbl | \fet0\sectd |

\linexO\endnhere\sectdefaultcl {\*\pnseclvl2\pnucrm\pnstart1\pnindent720\pnhang{\pntxta
}}{\*\pnseclvl2\pnucltr\pnstart1\pnindent720\pnhang{\pntxta .}}{\*\pnseclvl3
\pndec\pnstart1\pnindent720\pnhang{\pntxta
. }}{\*\pflseclvl4\pnlcltr\pnstart1\pnindent720\pnhang{\pntxta

| | |
|---|---|
| )}}{\*\pnseclvl5\pndec\pnstart1\pnindent720\pnhang{\pntxtb | (}{\pntxta |
| )}}{\*\pnseclvl6\pnlcltr\pnstart1\pnindent720\pnhang{\pntxtb | (}{\pntxta )}} |
| {\*\pnseclvl7\pnlcrm\pnstart1\pnindent720\pnhang{\pntxtb | (}{\pntxta |
| )}}{\*\pnseclvI8\pnlcltr\pnstart1\pnindent720\pnhang{\pntxtb | (}{\pntxta |

)}}{\*\pnseclvI9\pnlcrm\pnstart1\pnindent720\pnhang{\pntxtb (}{\pntxta )}}\pard\plain
\nowidctlpar\faauto\adjustright\rin0\lin0\itap0 \f20\fs28\lang1033\cgrid {Rear Derailleur
Installation

| | | |
|---|---|---|
| \par | }\pard\plain | \s18\sa40\nowidctlpar\faauto\adjustright\rin0\lin0\itap0 |

\b\f20\fs28\lang1033\cgrid {\page Overview

| | | |
|---|---|---|
| \par | }\pard\plain | \s19\sa20\nowidctlpar\faauto\adjustright\rin0\lin0\itap0 |

\f20\fs28\cf1\lang1033\cgrid {\page Shimano }{\cf2 Rapid Rise rear derailleurs}{have a
different installation procedure than other rear derailleurs.
\par }\pard\plain \s17\sa60\nowidctlpar\faauto\adjustright\rin0\lin0\itap0 \i\f20\lang1033\cgrid
{\page Learn more about Shimano Rapid Rise Rear Derailleur Installation
\par drrrin
\par overview

| | | |
|---|---|---|
| \par | }\pard\plain | \s19\sa20\nowidctlpar\faauto\adjustright\rin0\lin0\itap0 |

\f20\fs28\cf1\lang1033\cgrid {\page All instruction is based on the bicycle being correctly placed
in a proper }{\cf6 bicycle repair stand}{.
\par }\pard\plain \s17\sa60\nowidctlpar\faauto\adjustrig ht\rin0\lin0\itap0 \i\f20\lang1033\cgrid
{\page Learn how to use bicycle repair stands
\par toinbr
\par overview

| | | |
|---|---|---|
| \par | }\pard\plain | \s19\sa20\nowidctlpar\faauto\adjustright\rin0\lin0\itap0 |

\f20\fs28\cf1\lang1033\cgrid {\page All tool rotation directions assume that the mechanic is on
the same side of the bicycle as the tool in the ins
truction. Unless otherwise specified, clockwise is to tighten and counterclockwise is to loosen.
\par \page When installing a new rear derailleur, clean and lubricate or install a new }{\cf2
shifter cable}{and }{\cf2 shifter cable housing}{\cf0.
\par }\pard\plain\s17\sa60\nowidctlpar\faauto\adjustright\rin0\lin0\itap0 \i\f20\lang1033\cgrid
{\page Learn about Rear Shifter Cable Maintenance
\par cbrsml
\par overview
\par \page Learn about Rear Shifter Cable Installation
\par cbrsin
\par overview

| | | |
|---|---|---|
| \par | }\pard\plain | \s19\sa20\nowidctlpar\faauto\adjustright\rin0\lin0\itap0 |

\f20\fs28\cf1\lang1033\cgrid {\page The following procedure assumes that the }{\cf2 rear
wheel}{is installed on the bicycle with the }{\cf2 chain}{on the }{\cf2 small chainring}{ and
}{\cf2 smallest cassette sprocket}{.
\par }\pard\plain \s17\sa60\nowidctlpar\faauto\adjustright\rin0\lin0\itap0 \i\f20\lang1033\cgrid
{\page Learn about Rear Wheel Installation
\par rwwhin
\par overview

| | | |
|---|---|---|
| \par | }\pard\plain | \s18\sa40\nowidctlpar\faauto\adjustright\rin0\lin0\itap0 |

\b\f20\fs28\lang1033\cgrid {\page Install the rear derailleur

| | | |
|---|---|---|
| \par | }\pard\plain | \s19\sa20\nowidctl par\faauto\adjustright\rin0\lin0\itap0 |

\f20\fs28\cf1\lang1033\cgrid {\page Apply a thin layer of }{\cf6 grease}{to the threads of the
}{\cf2 rear derailleur hanger pivot bolt}{. Use an}{\cf2 }{\cf6 Allen wrench}{
to install the derailleur to the }{\cf2 rear derailleur hanger}{. Turn the wrench clockwise.
\par \page When tightening the derailleur hanger pivot bolt, make certain that the end of the
rear derailleur }{\cf2 B tension screw}{contacts the top of the derailleur hanger }{\cf2 B tension
tab}{.

| | | |
|---|---|---|
| \par | }\pard\plain | \s18\sa40\nowidctlpar\faauto\adjustright\rin0\lin0\itap0 |

\b\f20\fs28\lang1033\cgrid {\page Inspect the rear derailleur alignment

| | | |
|---|---|---|
| \par | }\pard\plain | \s19\sa20\nowidctlpar\faauto\adjustright\rin0\lin0\itap0 |

\f20\fs28\cfl\lang1033\cgrid {\page Inspect the rear derailleur}{\cf2 }{alignment. From the back
of the bicycle, pull the rear derailleur back and extend the }{\cf2
rear derailleur cage}{to expose the }{\cf2 rear derailleur pulleys}{. The pulleys must be in
perfect vertical alignment with the }{\cf2 cassette sprockets}{.
\par \page Pulleys that are not in perfect vertical alignment with the cassette sprockets suggest
a bent rear derailleur or rear derailleur hanger.
\par }\pard\plain \s17\sa60\nowidctlpar\faauto\adjustright\rin0\lin0\itap0 \i\f20\lang1033\cgrid
{\page Learn more about rear derailleur alignment
\par drrdte
\par rear derailleur alignment

| | | |
|---|---|---|
| \par | }\pard\plain | \s18\sa40\nowidctl par\faauto\adjustright\rin0\lin0\itap0 |

\b\f20\fs28\lang1033\cgrid {\page Pre-adjust the limit screws

| | | |
|---|---|---|
| \par | }\pard\plain | \s19\sa20\nowidctlpar\faauto\adjustright\rin0\lin0\itap0 |

\f20\fs28\cfl\lang1033\cgrid {\page Locate the }{\cf2 rear derailleur high limit screw }{on the
}{\cf2 rear}{}{\cf2 derailleur main body}{\cf0. The high limit screw is}{\cf2 }{
usually designated by the letter \ldblquote H\rdblquote.
\par }\pard\plain \s17\sa60\nowidctlpar\faauto\adjustright\rin0\lin0\itap0 \i\f20\lang1033\cgrid
{\page Learn how to locate the rear derailleur high limit screw
\par drrdte
\par rear derailleur limit screw identification

| | | |
|---|---|---|
| \par | }\pard\plain | \s19\sa20\nowidctlpar\faauto\adjustright\rin0\lin0\itap0 |

\f20\fs28\cfl\lang1033\cgrid {\page Use a }{\cf6 screwdriver}{to preset the high limit screw.
Turn the limit screw with the screwdriver until the }{\cf2 upper guide pulley}{
is in vertical alignment with the }{\cf2 smallest cassette sprocket}{.
\par \page Locate the }{\cf2 rear derailleur low limit screw}{on the rear derailleur main body.
The low limit screw is usually designated by the letter \ldblquote L\rdblquote.
\par }\pard\plain \s17\sa60\nowidctlpar\faauto\adjustright\rin0\lin0\itap0 \i\f20\lang1033\cgrid
{\page Learn how to locate the rear derailleur low limit screw
\par drrdte
\par rear derailleur limit screw identification

| | | |
|---|---|---|
| \par | }\pard\plain | \s19\sa20\nowidctlpar\faauto\adjustright\rin0\lin0\itap0 |

\f20\fs28\cfl\lang1033\cgrid {\page Actuate the rear derailleur parallelogram by hand and
extend the }{\cf2 rear derailleur cage}{. Align the upper guide pulley below the }{\cf2
largest cassette sprocket}{.
\par \page Use a screwdriver to preset the low limit screw. Turn the limit screw with the
screwdriver until the }{\cf2 upper guide pulley}{is in vertical alignment with the largest cassette
sprocket.

| | | |
|---|---|---|
| \par | }\pard\plain | \s18\sa40\nowidctlpar\faauto\adjustright\rin0\lin0\itap0 |

\b\f20\fs28\lang1033\cgrid {\page Install the chain

| | | |
|---|---|---|
| \par | }\pard\plain | \s19\sa20\nowidctlpar\faauto\adjustright\rin0\lin0\itap0 |

\f20\fs28\cfi\lang1033\cgrid {\page Use an}{\cf6 Allen wrench}{to loosen and remove the
}{\cf2 lower tension pulley}{\cf0 bolt. Turn the wrench counterclockwise.
\par }{\page The lower tension pulley will fall free from the }{\cf2 rear derailleur cage}{. Make
certain that the pulley bushings do not fall out of the pulley assembly and become lost.
\par \page Rotate the}{\cf2 rear derailleur inner cage}{forward and place the chain under }{\cf0
the upper guide pulley and}{through the rear derailleur cage. Make certain that the chain is
installed on the inside of the }{\cf2 rear}{}{\cf2
derailleur cage upper retention tab}{\cf0.
\par \page }{Position the lower tension pulley in front of the chain and into the rear derailleur
cage. }{\cf0 Lightly grease, i}{nsert and tighten the pulley bolt. Use an Allen wrench to turn the
bolt clockwise.
\par \page Use the Allen wrench to tighten }{\cf0 the upper guide pulley bolt. Turn}{ the wrench
clockwise. This is necessary, since the upper guide pulley bolt is loosened when the cage is
pivoted forward during chain installation.

| | | |
|---|---|---|
| \par | }\pard\plain | \s18\sa40\nowidctl par\faauto\adjustright\rin0\lin0\itap0 |

\b\f20\fs28\lang1033\cgrid {\page Adjust the b tension screw

| | | |
|---|---|---|
| \par | }\pard\plain | \s19\sa20\nowidctlpar\faauto\adjustright\rin0\lin0\itap0 |

\f20\fs28\cf1\lang1033\cgrid {\page When installing a SRAM ESP rear derailleur, it is
necessary to adjust the }{\cf2 chain gap}{. Begin to pedal and use your hand to actuate the
}{\cf2
rear derailleur parallelogram}{until the chain has shifted onto the largest cassette sprocket.
\par \page Make certain that there is a 4-6 mm chain gap between the upper guide pulley and
the largest cassette sprocket.
\par \page Use an Allen wrench or a screwdriver, depending on the manufacturer, to turn the
}{\cf2 B tension screw}{\cf0 . A}{clockwise rotation will increase the chain gap and a
counterclockwise rotation will decrease the chain gap.

| | | |
|---|---|---|
| \par | }\pard\plain | \s18\sa40\nowidctlpar\faauto\adjustright\rin0\lin0\itap0 |

\b\f20\fs28\lang1033\cgrid {\page Fasten the shifter cable

| | | |
|---|---|---|
| \par | }\pard\plain | \s19\sa20\nowidctlpar\faauto\adjustright\rin0\lin0\itap0 |

\f20\fs28\cfl\lang1033\cgrid {\page }{\b Tip:}{When installing a new rear derailleur, clean and
lubricate or install a new shifter cable }{\cf0 and shifter cable housing.}{\cf2
\par }\pard\plain \s17\sa60\nowidctlpar\faauto\adjustright\rin0\li nO\itap0 \i\f20\lang1033\cgrid
{\page Learn about Rear Shifter Cable Maintenance
\par cbrsml
\par overview
\par \page Learn about Rear Shifter Cable Installation
\par cbrsin
\par overview

| | | |
|---|---|---|
| \par | }\pard\plain | \s19\sa20\nowidctlpar\faauto\adjustright\rin0\lin0\itap0 |

\f20\fs28\cfl\lang1033\cgrid {\page Shift the }{\cf2 rear derailleur shifter}{into the smallest
cassette sprocket selection. This selection exposes the maximum amount of shifter cable.
\par \page Thread the shifter cable through the }{\cf2 rear derailleur housing stop}{.
\par \page Use an Allen wrench to loosen the }{\cf2 rear derailleur cable pinch bolt}{. Turn the
wrench counterclockwise.
\par \page Align the shifter cable within the cable groove on the cable pinch bolt. Tighten the
pinch bolt with the Allen wrench. Turn the wrench clockwise.
\par \page Make certain that the cable tension does not restrict the rear derailleur from shifting
the chain onto the smallest cassette sprocket.
\par \page Place a }{\cf2 cable end crimp}{over the end of the shifter cable. Use }{\cf6 diagonal
wire cutters}{to create two indentations on the crimp. The indentations must be deep enough
to grip the cable but not sever the crimp.
\par \page Adjust the rear derailleur.
\par }\pard\plain \s17\sa60\nowidctlpar\faauto\adjustright\rin0\lin0\itap0 \i\f20\lang1033\cgrid
{\page Learn about Rear Derailleur Adjustment
\par drrdad
\par overview
\par}}

Because of the defined tags and the formatting, the engine is able to discern what a particular text block is intended to indicate (e.g., how it is to be used in display, link/go-to, etc.). It's the same thing for each of the objects, text, rotated text, images, rotated images, etc. as depicted in FIGS. 2 and 3, which are representations of the pages defined by the DRRDIN.dat file above. As the parser associated with the engine reads the text block, it creates dynamic arrays and matrices for each of the types of blocks. For example, there may be nine objects that will create a step-by-step overview, there may be dynamic tools, and there may be words that are to be automatically associated with a glossary. Each of these types (e.g., dynamic tools, glossary terms) are associated with a type as a result of tag information contained in the text-based document. Accordingly, engine 50 creates dynamic arrays, hash tables, matrices to track and manage the various blocks.

A key feature of the present invention is an ability to utilize and work with small, highly compressed input images so as to produce multi-media programs that may be run on conventional computer equipment in a satisfactory fashion—meaning they will be responsive to the user and will not require long periods to load and display updated information. As Director has no JPEG compression capabilities it inherently reconstructs compressed images into larger files. The present system, however, contemplates the use of casts made up of one hundred or more cast members. With a cast of such size, it would be impossible to play a Director-created movie or output using typical computer workstations, because the storage and processing would require additional memory and high processor speeds. This is an inherent problem in Director, as everything is hard-coded and you must generally break down large movies into a series of smaller movies.

To solve the problem, the present system employs Director's Quicktime capability, by dynamically creating images in a Quicktime movie format, and then Quicktime is imbedded within Director. Through engine 50, a Quicktime cast is created as indicated by function 52B, where the “movie” may be a still image. The important point is that Director does not expand the “movie,” rather it merely takes it as an input without altering the storage size of the image. Thus, by using the Quicktime feature in association with Director small, highly compressed images (on the order of 10K bytes or less) remain at their original size. Then, through the tags associated with a text-based document, engine 50 creates a hash table 58 that associates the image with the corresponding text block. Through this hash table, the engine determines that there is an image associated with a particular piece of text and then dynamically creates a Quicktime “movie,” and in turn the movie is imbedded as a cast member. Hence, Quicktime controls the image compression, and images are not subject to Director's inherent processing, and expansion.

However, it will be appreciated by those familiar with the use of Director that use of Quicktime is usually done only in a direct-to-stage application—meaning that there is little control of the movie operation. In general, Quicktime takes over and is in the forefront and Director is just running in the background. However, for the display of images, that requirement creates problems for masking and control of other aspects of the image display in Director. Accordingly, the present invention further utilizes engine 50 to control Quicktime so that it shares the stage with Director. Using Director's Lingo interface, engine 50 has embedded different code segments to take over some of Director's raw controls.

Another control function enabled by engine 50 is the “tilting” of images. Here again, it will be appreciated that the rotation of images may result in the addition of what are commonly referred to as “jaggies” in image processing parlance. Jaggies arise when a line or edge between colors is rotated and the pixelation along the rotated line is then visible, particularly when the line is rotated to a significant degree from horizontal or vertical. To overcome the potential problem of jaggies on tilted images, engine 50 is further employed to first rotate the image at a high resolution (e.g., 600-1200 dpi, or greater). Once rotated, the image may then be cropped to the desired size. The result is that jaggies are eliminated or significantly reduced by the processing of engine 50, as opposed to simply tilting the image using functionality of Director or other software.

A similar problem was encountered with respect to the rotation of text in a scene (e.g., the text in region 130 of FIG. 2). When processing the tags in a text-based document, engine 50 identifies various tags that are either unsupported by Director, or for which improved functionality is provided outside of Director. For rotated-text tags not supported by Director, the present system employs a dynamic flash program as represented by function 52C. In particular the dynamic flash program is created to tile the text and the output is in turn, added to the Director cast to be inserted into the scene or screen image to be displayed.

As a further aspect of the present invention, it is contemplated that engine 50, or functions thereof, may be incorporated within a “wizard” or similar interface allowing a multi-media developer to quickly develop a media presentation, educational tool, etc. For example, where the function of parser 54 is implemented, it is further contemplated that such a wizard, parsing a text-based document, identifies particular portions of the document (e.g., a page or paragraph). Once identified or blocked, the wizard would then determine what type of block it is. Upon identification, the wizard can indicate any errors or deviations from the required format. Otherwise, the developer may be prompted to indicate that the text is a go-to block of text. The wizard would then provide the functionality for the developer to browse and pick the path of where to find the article or object associated with the go-to text. It is contemplated that such functionality may be directly enabled through engine 50, and the linkages formed thereby are intended to be represented by control/index data line 44 between engine 50 and database 40B.

Returning to the glossary function mentioned above and as represented by function 52D, and as further described below, engine 50 further includes sorting functionality to enable text blocks that define glossary terms to be processed. In particular, such items may include Quicktime and the glossary. As noted above, the invention uses a Quicktime movie for display of images. However, Quicktime is a format that does not allow naming of images, because it is a video format. The present invention, upon parsing a text-based document, identifies word strings with a “blue” tag, for example,as being associated with the glossary. Once added to the glossary list or matrix, the “blue” word within the matrix is assigned a sequential number as an index to the associated image. By parsing and processing the glossary and image data in this manner, the system associates a rollover pointer in a hash table (not shown) to an array that was dynamically created. And at the same time, in order to make sure everything works, the system goes through another sort algorithm to assign a sequential number, with a dynamic tag from the text, so that there is a one-to-one correlation between the text tag and related image.

Having described the basic functionality associated with system 30, attention is now directed to FIG. 4 where an exemplary embodiment for a program created by system 30 is depicted. As noted above, the presenting invention finds particular use in the development of multi-media presentations, particularly those intended as educational and/or information resources. One such embodiment is a repair and maintenance manual for mountain bikes. As depicted in FIG. 4, a computer system may be employed with a program developed by system 50, where a workstation 210 having a display 212 and a keyboard 214 are connected to a processor 216. Processor 216, as is well known, includes a removable media drive 218, preferably a mouse 220 or similar user input device, and peripheral devices such as a printer, speakers, etc. Within processor 216 is a microprocessor such as an Intel Pentium II, associated memory (RAM and magnetic media), a video controller, and other well-known components. It is also contemplated that computer system 210 may be a laptop or similar handheld/portable computer system, or possibly even a hand-held personal digital assistance (PDA) device.

Workstation 210 is preferably a PC or Mac system. For a Windows®-based system, the system should include a 300 MHz processor and operate on Windows 98® or later. For a Mac-based system, the workstation should include a Power PC processor and Mac OS ® 8.5 or later. The workstation preferably includes at least 128 Mbytes RAM and at least 100 Mbytes of hard disk storage space for installation of the BFR-It program.

In accordance with an aspect of the present invention, it is contemplated that a compact disk (CD-R, CD-RW, etc.) may be created with a self-executing multi-media program thereon. It is well known that Director enables such output to be created. As depicted in FIG. 4, system 210 would preferably have such a program loaded into its memory (not shown). A user of system 210 would, when seeking to perform maintenance or repairs on a mountain bike 230 simply initiate program 56 (FIG. 1) and access the pertinent information as will be further described below.

In an alternative or complimentary embodiment, workstation 210 may be connected to a network 250 via any one of a plurality of well-known wired or wireless connection methods. As shown in FIG. 4, the network may be the Internet or may facilitate a connection to the Internet. Hence, workstation 210 is capable of sending and receiving information related to the a software program, and where the network connection may be used to facilitate the transfer of information so as to enable a user to customize the program.

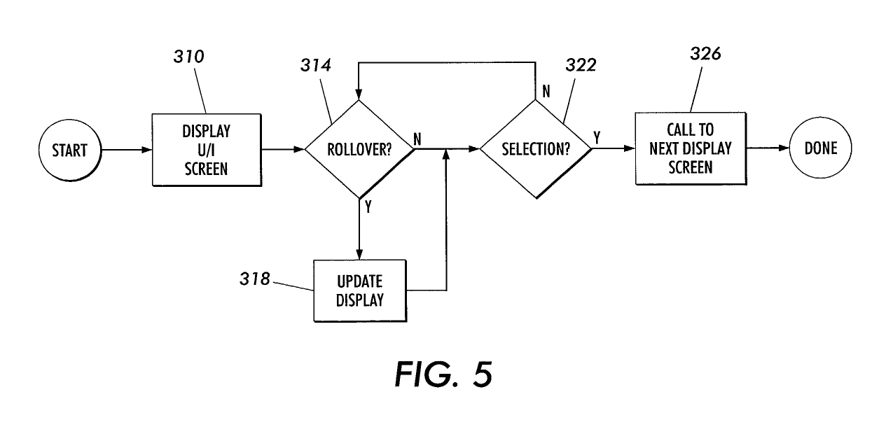

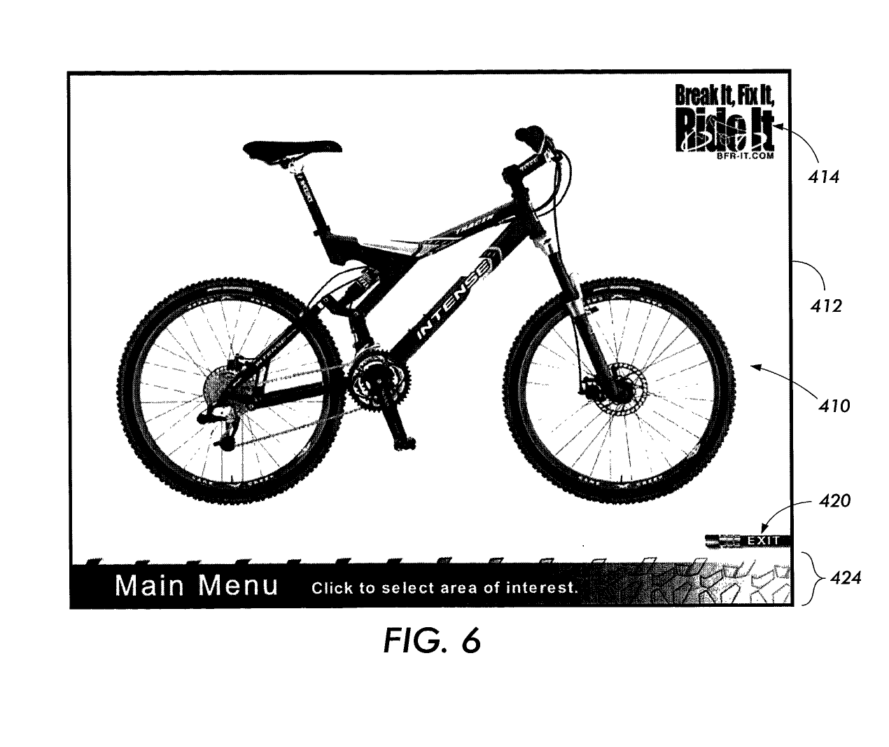

Referring next to FIG. 5, there is shown a flow chart illustrating, in a generalized fashion, the steps of program 56 as they relate to one or more of a series of “menu” screens or scenes depicted by the program. In particular, each screen is displayed first at step 310, where a number of objects are represented in the scene displayed. An example of such a display scene is shown in FIG. 6, where a bicycle 410 is illustrated in the center of a display 412. In addition to depicting the subject of the resource, bicycle 410, the scene depicted on display 412 may also include one or more advertisements 414, or menu navigation components that provide advertisement functionality (e.g., FIG. 2, Avocet navigational component 130). As is also illustrated in FIG. 6, the scene includes some user-selectable features such as an “Exit” object 420. Furthermore, along the bottom of the display there is a region 424 that characterizes the menu level (Main Menu) and provides user instructions.

Considering, briefly, the navigational feature 130 (depicted in FIGS. 2 and 3), FIG. 2 shows the response to the user's selection of the “Menu” button 158. In response to the selection, a main menu window 160 is displayed indicating the various options that the user has, including connection to a website (BFR-IT.COM), generation of a printable version of the information (including generating a .PDF or similarly printable file), and a help screen that explains the software and its operation. If the user selects the Menus or History objects in the main menu, a secondary menu window 162 is opened, depicting further options. For example, window 162 illustrates the various menu locations that a user could select. It will be appreciated that the navigation tool, and associated menus, are an alternative method of navigating through the system. It is further contemplated that the History feature depicted in FIG. 2, may not only show a current history of scenes or pages visited, but may also include a “save” feature, where a user may store the location they were at, and resume at that location upon re-entering the software. In that way, a user would be able to preserve the feature they were working through instead of having to retrace previously completed steps. In addition to saving a history or current position, the system may also be designed to allow a user to annotate the information and to save notes that a user could then review in subsequent sessions.

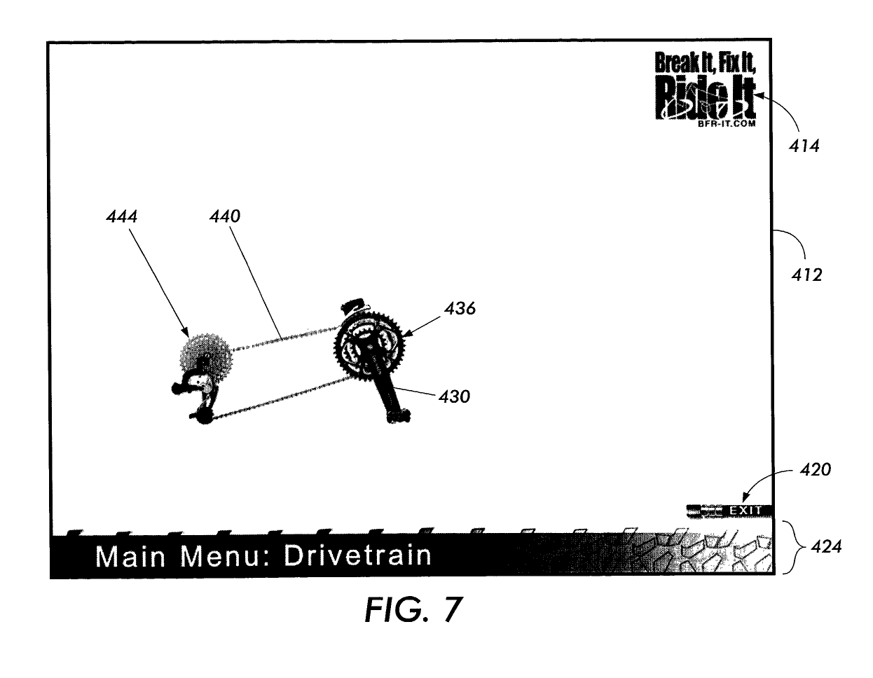

Referring again to FIG. 5, the menu of FIG. 6 is an interactive menu, where a user's options are depicted in a rollover format—meaning that the display object “behind” the cursor dynamically changes when the cursor is rolled over the object. For example, the test for a rollover, step 314, would wait to determine if a user had moved a cursor over a live, or interactive, region of the display. Just such a case is indicated in FIG. 7, where cursor 430 has been moved, in response to a user input device, to a position over the crank arm and chain ring assembly 436. In doing so, the coordinates of the cursor changed to a coordinate recognized by rollover test 314. In response to the detection of a rollover (where the cursor is positioned over an area of the image that is a selectable “menu” item), the display is updated as indicated at step 318 and as depicted in FIG. 7.

More specifically, display update 318 results in a revision to the scene depicted, where the portion of the display corresponding to the cursor position is left in the foreground (drivetrain display including chain ring and crank assembly 436, chain 440 and rear derailleur assembly 444), while the balance of the mountain bike image is moved to the background. Background components are indicated by a transparent/washed out or alternatively colored representation so as to clearly indicate they are not available for selection by the user.

Once the display has been updated, the interactive menu interface awaits a user selection of the rollover item at step 322. It will be appreciated that such a selection may be made by any of a number of selection indicators, including but not limited to a mouse click, or a user depressing the Enter key on an associated keyboard. Upon selection, processing would continue at step 326, by a call to a lower level display screen, where the general process steps of FIG. 5 would be repeated. Absent a selection, processing continues in the test loops (steps 314 and 322) until the user moves the cursor to another selectable regions of the menu, or to a non-interactive region.

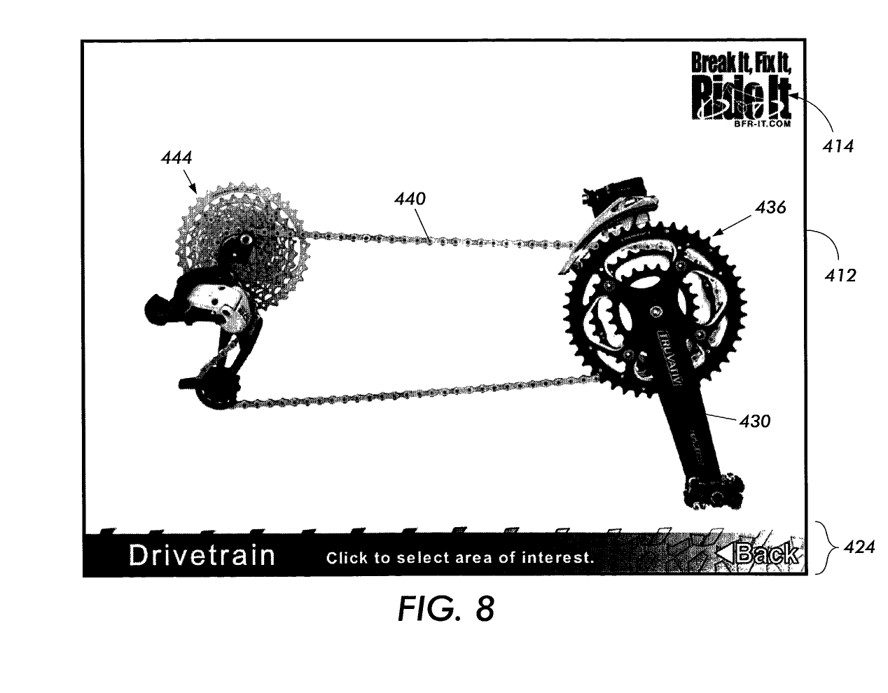

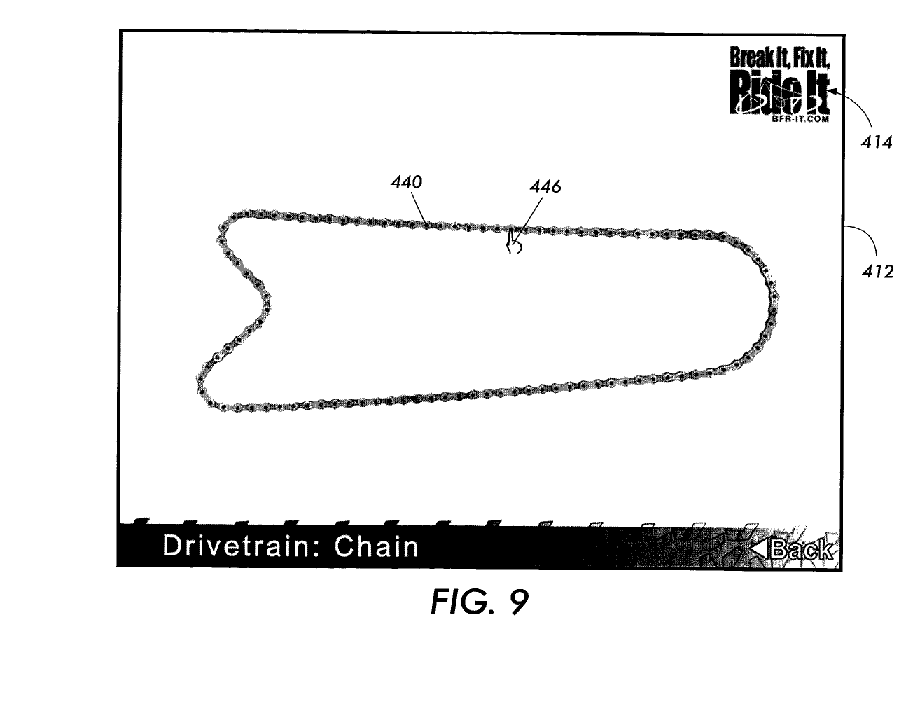

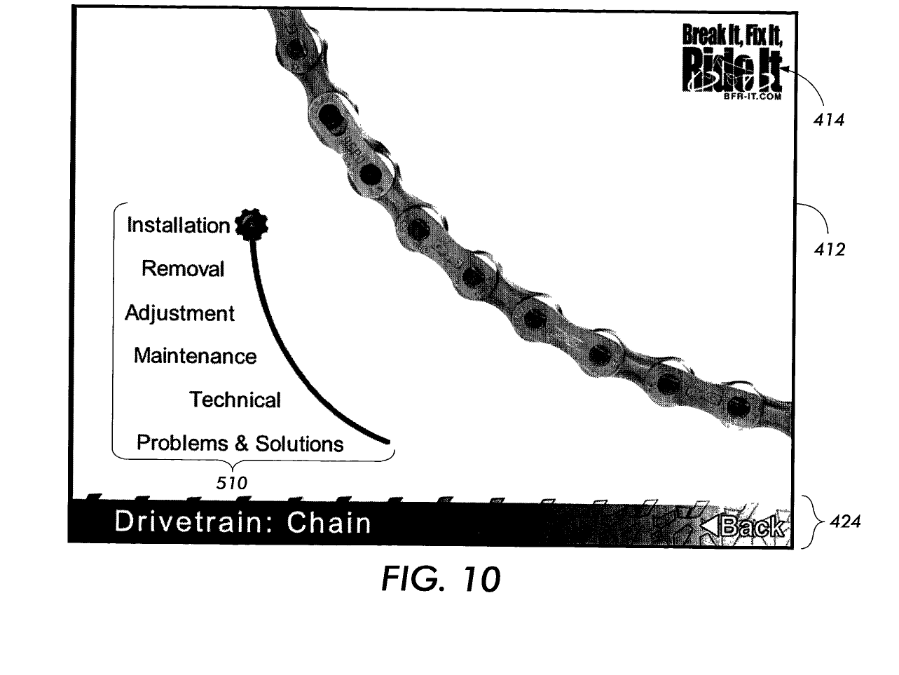

Simulating a user's selection with a cursor 430 positioned as indicated in FIG. 7, the menu screen of FIG. 8 would be displayed as a result of step 326. Although including similar display features (advertisement 414 and menu title region 424), the scene is now an enlarged view of the drive train of FIG. 7. Here again, the drive train itself may be broken down into a number of selectable component images, some or all of which may be sensitive to rollover and selection as described above. For example, referring to FIG. 8 in conjunction with FIG. 9, it is apparent that a user seeking information about chain repair or maintenance may having gotten to the Drive Train menu of FIG. 8. Subsequently, the user might move a cursor over chain 440, as depicted by cursor 446 in FIG. 9, to indicate that the chain is the component of interest. Hence, the chain 440 is depicted in the foreground, whereas the other objects of the Drive Train menu (crank and chain ring assembly 436 and derailleur assembly 444) are shown as background images. Here again, selection via a mouse, with a cursor as positioned in FIG. 9, will result in the display of a scene similar to the screen of FIG. 10.

It will be appreciated that the repeated process of FIG. 5, executed in association with the scenes depicted in FIGS. 6-9 provides a hierarchical user interface for displaying a plurality of pages or scenes related to the piece of equipment being repaired or maintained. Although depicted with respect to a mountain bike, it is also contemplated that such a system may be employed for other types of sporting equipment, for machinery and vehicle maintenance, diagnosis and repair, as well as for office equipment and appliance maintenance and repair. Similarly, the invention is not limited to repair and service instruction, but may be employed relative to other educational information such as sales and marketing training. It is believed that the multi-dimensional display facilitated by the rollover images, provides a unique and very user-friendly interface, particularly for users who may not be keenly aware of the names of components found in the equipment.

As a further modification of the embodiment depicted, it is contemplated that the present invention, as enabled by the ease of programming previously described, may be implemented so as to provide a customized interface for particular bicycle manufacturers or component suppliers. For example, it is entirely possible for a user to identify a particular bicycle model, or even components thereon, before beginning use of the program 56. Based upon the user's input, the program may be dynamically updated to display images that are of the same model and components that the user has on the bicycle being worked on. The user may be presented with the same or similar textual information, but the images, or more likely the image links, would be dynamically updated to provide display scenes that were accurate to a model or even a component level. Not only would such a system be of value to a user, but it may also be of value to equipment manufacturers who could then provide customized maintenance and repair information. Or, manufacturers could be sponsors of programs prepared to feature their components in the maintenance and repair examples, thereby encouraging the purchase of such components in the future.

It is further contemplated that aspects of the present invention may be implemented as a networked or Internet-based system, where program 56 is dynamically created for a user after an initial query as to the make, model, and/or components on the user's bicycle. Due to the various features of the multi-media creation system described with respect to FIG. 1, it will be appreciated that network and internet communication of an executable program would not be band-width prohibited. Moreover, the base software might be distributed via a removable media such as a CD-ROM, and subsequent updates to the images could be accomplished through network download, where the updates would include images particular to the user-provided make, model and component data.

Having described the operation of the hierarchical menu system in accordance with an aspect of the present invention, attention is now turned to further examples of the use of text-based documents as the input to the dynamic creation of the user interface scenes, including a combination of text and image-based information. Reference is also made to the following examples,, where particular detail of visual basic information is depicted for exemplary files that may be used to generate one or more user interface scenes in accordance with aspects of the present invention:

### CHAIN INSTALLATION SCREEN

```
<html xmlns:o=“urn:schemas-microsoft-com:office:office”
xmlns:w=“urn:schemas-microsoft-com:office:word”
xmlns=“http://www.w3.org/TR/REC-html40”>
<head>
<meta http-equiv=Content-Type content=“text/html; charset=windows-1252”>
<meta name=ProgId content=Word.Document>
<meta name=Generator content=“Microsoft Word 9”>
<meta name=Originator content=“Microsoft Word 9”>
<link rel=File-List href=“./DRCHIN%20_files/filelist.xml”>
<title>CHAIN INSTALLATION</title>
<!−−[if gte mso 9]><xml>
  <o:DocumentProperties>
  <o:Author>Harve</o:Author>
  <o:LastAuthor>will</o:LastAuthor>
  <o:Revision>14</o:Revision>
  <o:TotalTime>51 </o:TotalTime>
  <o:Created>2001-03-21T18:54:00Z</o:Created>
  <o:LastSaved>2001-04-27T18:57:00Z</o:LastSaved>
  <o:Pages>1</o:Pages>
  <o:Words>185</o:Words>
  <o:Characters>1060</o:Characters>
  <o:Company>SMP</o:Company>
  <o:Lines>8</o:Lines>
  <o:Paragraphs>2</o:Paragraphs>
  <o:CharactersWithSpaces>1301</o:CharactersWithSpaces>
  <o:Version>9.4119</o:Version>
  </o:DocumentProperties>
</xml>![endif]−−><!−−[if gte mso 9]><xml>
  <w:WordDocument>
  <w:View>Normal</w:View>
  <w:DoNotHyphenateCaps/>
  <w:PunctuationKerning/>
  <w:DisplayHorizontalDrawingGridEvery>0</w:DisplayHorizontalorawingGridEvery>
  <w:DisplayVerticalDrawingGridEvery>0</w:DisplayVerticalDrawingGridEvery>
  <w:Compatibility>
    <w:FootnoteLayoutLikeWW8/>
    <w:ShapeLayoutLikeWW8/>
    <w:AlignTablesRowByRow/>
    <w:ForgetLastTabAlignment/>
    <w:DoNotUseHTMLParagraphAutoSpacing/>
    <w:LayoutRawTableWidth/>
    <w:LayoutTableRowsApart/>
  </w:Compatibility>
  <w:DoNotOptimizeForBrowser/>
  </w:Word Document>
</xml><![endif]−−>
<style>
<!−−
/* Font Definitions */
@font-face
```

{font-family:“Comic Sans MS”;
panose-1:3 15 7 2 3 3 2 2 2 4;
mso-font-charset:0;
mso-generic-font-family:script;
mso-font-pitch:variable;
mso-font-signature:647 0 0 0 159 0;}

/* Style Definitions */
p.MsoNormal, li.MsoNormal, div.MsoNormal

{mso-style-parent:“”;
margin:0in;
margin-bottom:.0001pt;
mso-pagination:none;
text-autospace:none;
font-size:14.0pt;
font-family:“Comic Sans MS”;
mso-fareast-font-family:“Times New Roman”;
mso-bidi-font-family:“Times New Roman”;}

p.MsoCommentText,li.MsoCommentText,div.MsoCommentText

{margin:0in;
margin-bottom:.0001pt;
mso-pagination:none;
text-autospace:none;
font-size:10.0pt;
font-family:“Comic Sans MS”;
mso-fareast-font-family:“Times New Roman”;
mso-bidi-font-family:“Times New Roman”;}

span.MsoCommentReference

{mso-ansi-font-size:8.0pt;
mso-bidi-font-size:8.0pt;}

p.GoTo, li.GoTo, div.GoTo

{mso-style-name:“Go To”;
mso-style-update:auto;
margin-top:0in;
margin-right:0in;
margin-bottom:3.0pt;
margin-left:0in;
mso-pagination:none;
text-autospace:none;
font-size:12.0pt;
font-family:“Comic Sans MS”;
mso-fareast-font-family:“Times New Roman”;
mso-bidi-font-family:“Times New Roman”;
font-style:italic;}

p.StepHeading, li.StepHeading, div.StepHeading

{mso-style-name:“Step Heading”;
mso-style-update:auto;
margin-top:0in;
margin-right:0in;
margin-bottom:2.0pt;
margin-left:0in;
mso-pagination:none;
text-autospace:none;
font-size:14.0pt;
font-family:“Comic Sans MS”
mso-fareast-font-family:“Times New Roman”;
mso-bidi-font-family:“Times New Roman”;
font-weight:bold;}

p.TextBlockNormal, li.TextBlockNormal, div.TextBlockNormal

{mso-style-name:“Text Block Normal”;
mso-style-update:auto;
mso-style-parent:“Step Heading”;
margin-top:0in
margin-right:0in;
margin-bottom:1.0pt;
margin-left:0in;
mso-pagination:none;
text-autospace:none;
font-size:14.0pt;
font-family:“Comic Sans MS”;
mso-fareast-font-family:“Times New Roman”;
mso-bidi-font-family:“Times New Roman”;
color:black;}

@page Section1

{size:8.5in 11.0in;
margin:1.0in 1.25in 10in 1.25in
mso-header-margin:.5in;
mso-footer-margin:.5in;
mso-paper-source:0;}

div.Section1

{page:Section1;}

/* List Definitions */
@list l0

{mso-list-id:9;
mso-list-type:simple;
mso-list-template-ids:0;}

@list l0:level1

{mso-level-start-at:8;
mso-level-tab-stop:.25in;
mso-level-number-position:left;
margin-left:.25in;
text-indent:−.25in;}

ol

{margin-bottom:0in;}

ul

(margin-bottom:0in;}

−−>
</style>
</head>
<body lang=EN-US style=‘tab-interval:.5in’>
<div class=Section1>
<p class=MsoNormal>Chain installation</p>
<b><span style=‘font-size:14.0pt;font-family:“Comic Sans MS”;mso-fareast-font-family:
“Times New Roman”;mso-bidi-font-family:“Times New Roman”;mso-ansi-language:
EN-US;mso-fareast-language:EN-US;mso-bidi-language:AR-SA’><br clear=all
style=‘page-break-before:always’>
</span></b>
<p class=StepHeading>Overview</p>
<span style=‘font-size:14.0pt;font-family:“Comic Sans MS”;mso-fareast-font-family:
“Times New Roman”;mso-bidi-font-family:“Times New Roman”;color:black;
mso-ansi-language:EN-US;mso-fareast-language:EN-US;mso-bidi-language:AR-SA’><br
clear=all style=‘page-break-before:always’>
</span>
<p class=TextBlockNormal>All instruction is based on the bicycle being
correctly placed in a proper <span style=‘color:red’>bicycle repair stand</span>/</p>
<i><span style=‘font-size:10.0pt;font-family:“Comic Sans MS”;mso-fareast-font-family:
“Times New Roman”;mso-bidi-font-family:“Times New Roman”;mso-ansi-language:
EN-US;mso-fareast-language:EN-US;mso-bidi-language:AR-SA’><br clear=all
style=‘page-break-before:always’>
</span></i>
<p class=GoTo><span style=‘font-size:10.0pt’>Learn how to use bicycle repair
stands<o:p></o:p></span></p>
<p class=GoTo><span style=‘font-size:10.0pt’>zz<o:p></o:p></span></p>
<b><span style=‘font-size:14.0pt;font-family:“Comic Sans MS”;mso-fareast-font-family:
“Times New Roman”;mso-bidi-font-family:“Times New Roman”;mso-ansi-language:
EN-US;mso-fareast-language:EN-US;mso-bidi-language:AR-SA’><br clear=all
style=‘page-break-before:always’>
</span></b>
<p class=StepHeading>Prepare for chain installation</p>
<span style=‘font-size:14.0pt;font-family:“Comic Sans MS”; mso-fareast-font-family:
“Times New Roman”; mso-bidi-font-family:“Times New Roman”;color:black;
mso-ansi-language:EN-US;mso-fareast-language:EN-US;mso-bidi-language:AR-SA’><br
clear=all style=‘page-break-before:always’>
</span>
<p class=TextBlockNormal>Use the<span style=‘color:windowtext’></span><span
style=‘color:blue’>shifters</span>to shift the chain onto the <span
style=‘color:blue’>small chainring</span>and the <span style=‘color:blue’>smallest
cassette sprocket</span>.</p>
<b><span style=‘font-size:14.0pt;font-family:“Comic Sans MS”;mso-fareast-font-family:
“Times New Roman”;mso-bidi-font-family:“Times New Roman”;mso-ansi-language:
EN-US;mso-fareast-language:EN-US;mso-bidi-language:AR-SA’><br clear=all
style=‘page-break-before:always’>
</span><Ib>
<p class=StepHeading>Loosen the assembled chain link</p>
<span style=‘font-size:14.0pt;font-family:“Comic Sans MS”;mso-fareast-font-family:
“Times New Roman”;mso-bidi-font-family:“Times New Roman”;color:black;
mso-ansi-language:EN-US;mso-fareast-language:EN-US;mso-bidi-language:AR-SA’><br
clear=all style=‘page-break-before:always’>
</span>
<p class=TextBlockNormal>Chain links that are assembled with a chain tool are
usually stiff. Place the link that was pressed together in the secondary cradle
of the chain tool.</p>
<span style=‘font-size:14.0pt;font-family:“Comic Sans MS”;mso-fareast-font-family:
“Times New Roman”;mso-bidi-font-family:“Times New Roman”;color:black;
mso-ansi-language:EN-US;mso-fareast-language:EN-US;mso-bidi-language:AR.SA’><br
clear=all style=‘page-break-before:always’>
</span>
<p class=TextBlockNormal>Turn the handle clockwise until the driver pin
contacts and is aligned with the rivet pin.</p>
<span style=“font-size:14.0pt;font-family:“Comic Sans MS”;mso-fareast-font-family:
“Times New Roman”;mso-bidi-font-family:“Times New Roman”;color:black;
mso-ansi-language:EN-US;mso-fareast-language:EN-US;mso-bidi-language:AR-SA5<br
clear=all style=‘page-break-before:always’>
</span>
<p class=TextBlockNormal>Turn the handle ⅛ of a turn clockwise. Apply only a
slight amount of force to the rivet pin. This will loosen the stiff chain iink.</p>
<b><span style=‘font-size:14.0pt;font-family:“Comic Sans MS”;mso-fareast-font-family:
“Times New Roman”;mso-bidi-font-family:“Times New Roman”;mso-ansi-language:
EN-US;mso-fareast-language:EN-US;mso-bidi-language:AR-SA’><br clear=all
style=‘page-break-before:always’>
</span></b>
<p class=StepHeading>Inspect the chain link</p>
<span style=‘font-size:14.0pt;font-family:“Comic Sans MS”;mso-fareast-font-family:
“Times New Roman”;mso-bidi-font-family:“Times New Roman”;color:black;
mso-ansi-language:EN-US;mso-fareast-language:EN-US;mso-bidi-language:AR-SA’><br
clear=alI style=‘page-break-before:always’>
</span>
<p class=TextBlockNormal>Remove the tool from the chain and inspect the chain
link. Make certain that the rivet pin is centered between the outer chain
plates.</p>
<span style=‘font-size:14.0pt;font-family:“Comic Sans MS”;mso-fareast-font-family:
“Times New Roman”;mso-bidi-font-family:“Times New Roman”;color:black;
mso-ansi-language:EN-US;mso-fareast-language:EN-US;mso-bidi-language:AR-SA’><br
clear=all style=‘page-break-before:always’>
</span>
<p class=TextBlockNormal>Hold the chain on both sides of the chain link and
apply lateral pressure back and forth to the link. Make certain that the link
functions properly without binding.</p>
<b><span style=‘font-size:14.0pt;font-family:“Comic Sans MS”;mso-fareast-font-family:
“Times New Roman”;mso-bid i-font-family:“Times New Roman”;mso-ansi-language:
EN-US;mso-fareast-language:EN-US;mso-bidi-language:AR-SA’><br clear=all
style=‘page-break-before:always’>
</span></b>
<p class=StepHeading>Verify the final chain length</p>
<span style=‘font-size:14.0pt;font-family:“Comic Sans MS”;mso-fareast-font-family:
“Times New Roman”;mso-bidi-font-family:“Times New Roman”;color:black;
mso-ansi-language:EN-US;mso-fareast-language:EN-US;mso-bidi-language:AR-SA’><br
clear=all style=‘page-break-before:always’>
</span>
<p class=TextBlockNormal>If the <span style=‘color:blue’>rear derailleur cage</span>
is parallel to the <span style=‘color:blue’>chainline</span>as it shifts onto
the largest cassette sprocket, the derailleur is overextended. Separate the
chain and add an additional link to accommodate the drivetrain.</p>
</div>
<body>
</html>

### Chain Adjust Screen

```
<html xmlns:o=“urn:schemas-microsoft-com:office:office”
xmlns:w=“urn:schemas-microsoft-com:office:word”
xmlns=“http://www.w3.org/TR/REC-html40”>
<head>
<meta http-equiv=Content-Type content=“text/html; charset=windows-1252”>
<meta name=ProgId content=Word.Document>
<meta name=Generator content=“Microsoft Word 9”>
<meta name=Originator content=“Microsoft Word 9”>
<link rel=File-List href=“./DRCHAD%20_files/filelist.xml”>
<title>CHAIN ADJUST</title>
<!−−[if gte mso 9]><xml>
  <o:DocumentProperties>
  <o:Author>Harve</o:Author>
  <o:LastAuthor>will</o:LastAuthor>
  <o:Revision>13</o:Revision>
  <o:TotalTime>61</o:TotalTime>
  <o:Created>2001-03-21T18:55:00Z</o:Created>
  <o:LastSaved>2001-04-27T19:01:00Z</o:LastSaved>
  <o:Pages>1 </o:Pages>
  <o:Words>43</o:Words>
  <o:Characters>248</o:Characters>
  <o:Company>SMP</o:Company>
  <o:Lines>2</o:Lines>
  <o:Paragraphs>1</o:Paragraphs>
  <o:CharactersWithSpaces>304</o:CharactersWithspaces>
  <o:Version>9.4119</o:Version>
  </o:DocumentProperties>
</xml><![endif]−−><!−−[if gte mso 9]><xml>
  <w:WordDocument>
  <w:View>Normal</w:View>
  <w:HyphenationZone>0</w:HyphenationZone>
  <w:DoNotHyphenateCaps/>
  <w:Punctuation Kerning/>
  <w:DrawingGridHorizontalSpacing>0 pt</w:DrawingGridHorizontaiSpacing>
  <w:DrawingGridVerticalSpacing>0 pt</w:DrawingGridVerticalSpacing>
  <w:DisplayHorizontalDrawingGridEvery>0</w:DisplayHorizontaIDrawingGridEvery>
  <w:DisplayVerticalDrawingGridEvery>0</w:DisplayverticalDrawingGridEvery>
  <w:DoNotShadeFormData/>
  <w:Compatibility>
    <w:OrigWordTableRules/>
    <w:NoLeading/>
    <w:SpacingInWholePoints/>
    <w:ShowBreaksInFrames/>
    <w:SuppressTopSpacing/>
    <w:SuppressTopSpacing Mac5/>
    <w:MWSmallCaps/>
    <w:UsePrinterMetrics/>
    <w:WW6BorderRules/>
    <w:FootnoteLayoutLikeWW8/>
    <w:ShapeLayoutLikeWW8/>
    <w:AlignTablesRowByRow/>
    <w:ForgetLastTabAlignment/>
    <w:DoNotUseHTMLParagraphAutoSpacing/>
    <w:LayoutRawTableWidth/>
    <w:LayoutTableRowsApart/>
    </w:Compatibility>
    <w:DoNotOptimizeForBrowser/>
  </w:WordDocument>
</xml><[endif]−−>
<style>
<!−−
/* Font Definitions */
@font-face
```

{font-family:“Comic Sans MS”
panose-1:3 15 7 2 3 3 2 2 2 4;
mso-font-charset:0;
mso-generic-font-family:script;
mso-font-pitch:variable;
mso-font-signature:647 0 0 0 159 0;}

/* Style Definitions */
p.MsoNormal, li.MsoNormal, div.MsoNormal

{mso-style-parent:“”;
margin:0in;
margin-bottom:.0001pt;
mso-pagination:none;
text-autospace:none;
font-size:14.0pt;
font-family:“Comic Sans MS”;
mso-fareast-font-family:“Times New Roman”;
mso-bidi-font-family:“Times New Roman”;}

p.MsoCommentText, liMsoCommentrext, div.MsoCommentText

{margin:0in;
margin-bottom:.0001pt;
mso-pagination:none;
text-autospace:none;
font-size:10.0pt;
font-family:“Comic Sans MS”;
mso-fareast-font-family:“Times New Roman”;
mso-bidi-font-family:“Times New Roman”;}

span.MsoCommentReference

{mso-ansi-font-size:8.0pt;
mso-bidi-font-size:8.0pt;}

p.GoTo, li.GoTo, div.GoTo

{mso-style-name:“Go To”;
mso-style-update:auto;
margin-top:0in;
margin-right:0in;
margin-bottom:3.0pt;
margin-left:0in;
mso-pagination:none;
text-autospace:none;
font-size:12.0pt;
font-family:“Comic Sans MS”;
mso-fareast-font-family:“Times New Roman”;
mso-bidi-font-family:“Times New Roman”;
font-style:italic;}

p.StepHeading, li.StepHeading, div.StepHeading

{mso-style-name:“Step Heading”;
mso-style-update:auto;
margin-top:0in;
margin-right:0in;
margin-bottom:2.0pt;
margin-left:0in;
mso-pagination:none;
text-autospace:none;
font-size:14.0pt;
font-family:“Comic Sans MS”;
mso-fareast-font-family:“Times New Roman”;
mso-bidi-font-family:“Times New Roman”;
font-weight:bold;}

p.TextBlockNormal, li.TextBlockNormal, div.TextBlockNormal

{mso-style-name:“Text Block Normal”;
mso-style-update:auto;
mso-style-parent:“Step Heading”;
margin-top:0in
margin-right:0in;
margin-bottom:1.0pt;
margin-left:0in;
mso-pagination:none;
text-autospace:none;
font-size:14.0pt;
font-famiiy:“Comic Sans MS”;
mso-fareast-font-family:“Times New Roman”;
mso-bidi-font-family:“Times New Roman”;
color:black;}

/* Page Definitions */
@page

{mso-page-border-surround-header:no;
mso-page-border-surround-footer:no;}

@page Section1

{size:8.5in 11.0in;
margin:1.0in 1.25in 1.0in 1.25in;
mso-header-margin:.5in;
mso-footer-margin:.5in;
mso-paper-source:0;}

div.Section1

{page:Section1;}

−−>
</style>
<head>
<body lang=EN-US style=‘tab-interval:.5in’>
<div class=Section1>
<p class=MsoNormal>Chain Adjustment</p>
<b><span style=‘font-size:14.0pt;font-family:“Comic Sans MS”;mso-fareast-font-family:
“Times New Roman”;mso-bidi-font-family:“Times New Roman”;mso-ansi-language:
EN-US;mso-fareast-language:EN-US;mso-bidi-language:AR-SA’><br clear=all
style=‘page-break-before:always’>
</span></b>
<p class=StepHeading>Add a chain link</p>
<span style=‘font-size:14.0pt;font-family:“Comic Sans MS”;mso-fareast-font-family:
“Times New Roman”;mso-bidi-font-family:“Times New Roman”;color:black;
mso-ansi-language:EN-US;mso-fareast-language:EN-US;mso-bidi-language:AR-SA’><br
clear=all style=‘page-break-before:always’>
</span>
<p class=TextBlockNormal>Add one <span style=‘color:blue’>chain</span><span
style=‘color:blue’>link</span>to the chain. Only add a chain link if the chain
has not worn past the recommended <span style=‘color:blue’>chain stretch</span>
replacement length. To add a chain link, use the same procedure that is used to
connect the chain.</p>
<i><span style=‘font-size:10.0pt;font-family:“Comic Sans MS”;mso-fareast-font-family:
“Times New Roman”;mso-bidi-font-family:“Times New Roman”;mso-ansi-language:
EN-US;mso-fareast-language:EN-US;mso-bidi-language:AR-SA’><br clear=all
style=‘page-break-before:always’>
</span></i>
<p class=GoTo><span style=‘font-size:10.0pt’>Learn how to measure the
chain<o:p></o:p></span></p>
<p class=GoTo><span style=‘font-size:10.0pt’>drchte<o:p></o:p></span></p>
<p class=GoTo><span style=‘font-size:10.0pt’>chain wear<o:p></o:p></span></p>
</div>
</body>
</html>

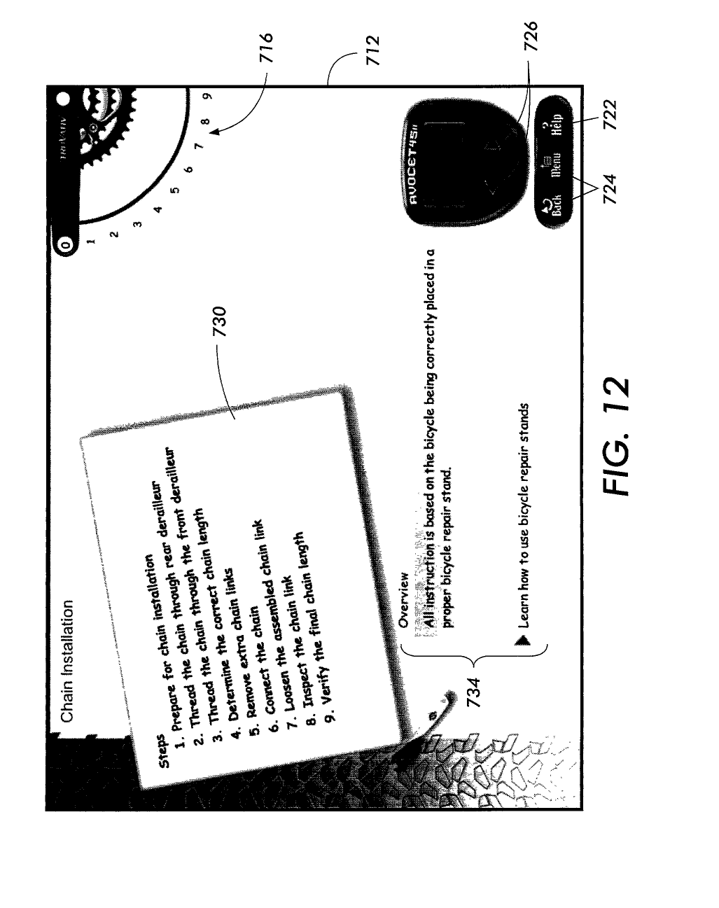

Referring to FIG. 10, a user may move a cursor to select any of the particular topics displayed in the textual portion of the scene, region 510. Upon selecting the “Installation,” a user would be presented with a user-interface display similar to that depicted in FIG. 12. In particular, FIG. 12 illustrates a drive chain installation procedure and related information, the generation of which is accomplished in accordance with the text-based document depicted in FIG. 11 (and the detailed listing of which appears in CHAIN INSTALLATION SCREEN code example above). FIG. 11 is an exemplary representation of a file DRCHAIN.doc that was processed by the engine of the present invention to dynamically create the output of display 712 in FIG. 12.

As in the prior example, display 712 preferably includes a consistent layout with particular information on each of the screens displayed. For example, a crank set image 716 has been used in the upper right corner of the display to depict the stage of the installation procedure. In the lower right corner, depicted as a cyclometer 720, are sets of user-selectable buttons 722, 724, 726 that allow the user to navigate through the chain installation procedure steps.

The balance of the scene is divided into a set of installation steps in tilted text region 730, and Overview region 734. The wording for the Overview region 734 is determined from the text-based document 610 depicted in FIG. 11. In particular, the heading “Overview” 620 indicates that the text following the heading is to be included in the overview region 734. However, in addition to simply displaying the associated text, there is additional information embedded within the visual-basic text. For example, a closer analysis of CHAIN INSTALLATION SCREEN reveals the following sequence of tags and textual information:

“<p class=StepHeading>Overview</p>
<span style=‘font-size:14.0pt;font-family:“Comic Sans MS”;mso-fareast-
font-family:“Times New Roman”;mso-bidi-font-family:“Times New
Roman”;color:black;mso-ansi-language:
EN-US;mso-fareast-language:EN-US;mso-bidi-language:AR-SA’><br
clear=all style=‘page-break-before:always’>
</span>
<p class=TextBlockNormal>All instruction is based on the bicycle being
correctly placed in a proper <span style=‘color:red’>bicycle repair
stand</span>.</p>
<i><span style=‘font-size:10.0pt;font-family:“Comic
Sans MS”;mso-fareast-font-family:“Times New Roman”;mso-bidi-font-
family:“Times New Roman”;mso-ansi-language:EN-US;mso-fareast-
language:EN-US;mso-bidi-language:AR-SA’><br clear=all
style=‘page-break-before:always’>
</span></i>
<p class=GoTo><span style=‘font-size:10.0pt’>Learn how to use bicycle
repair stands<o:p></o:p></span></p>
<p class=GoTo><span style=‘font-size:10.0pt’>zz<o:p></o:p></span>
</p>
<b><span style=font-size:14.0pt;font-family:“Comic Sans MS”;mso-
fareast-font-family:“Times New Roman”;mso-bidi-font-family:“Times
New Roman”;mso-ansi-language:EN-US;mso-fareast-language:EN-US;
mso-bidi-language:AR-SA’><br clear=all style=‘page-break-
before:always’>
</span></b>”

In addition to specifying the character strings to be depicted in the Overview region, the above information, and similarly region 624 on FIG. 11, specifies that the phrase “bicycle repair stand” (tagged as “red” text) is to be further processed. In particular, the processing indicated is that the phrase is to be added to a glossary of terms and may have an image associated with it in order to provide further information on bicycle repair stands to a novice user of the program. Processing of the red-tagged term(s) by the engine, where it will be linked to an associated go-to scene, will subsequently change the tag to blue text, so that a blue is consistently used throughout the user interface to represent selectable of linked text in the final output program.

The text for the steps depicted in region 730 is found in the text-based document, in region 640, only a portion of which is illustrated in FIG. 11 (see CHAIN INSTALLATION SCREEN for a more complete example in a visual basic representation).

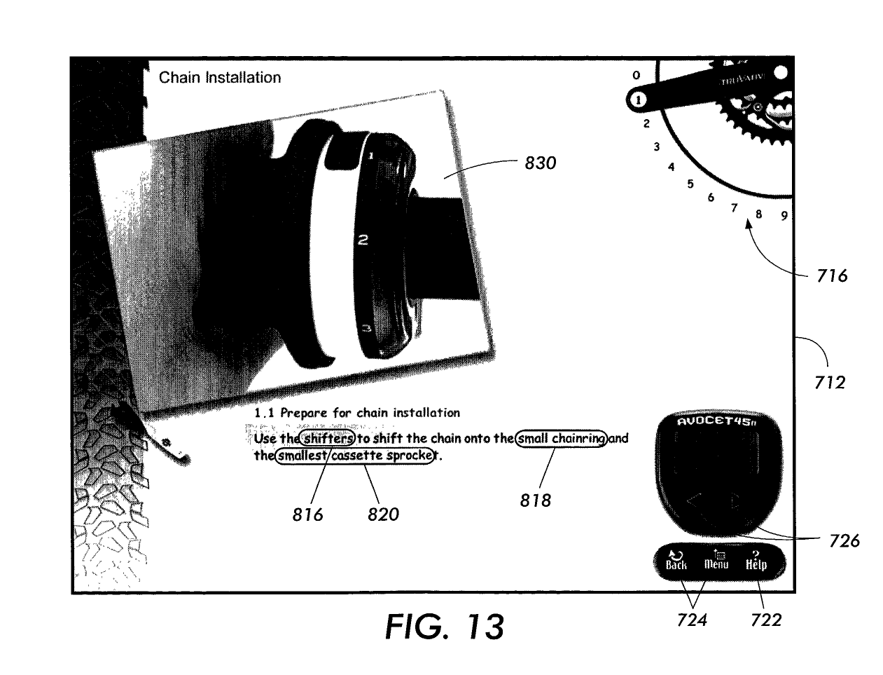

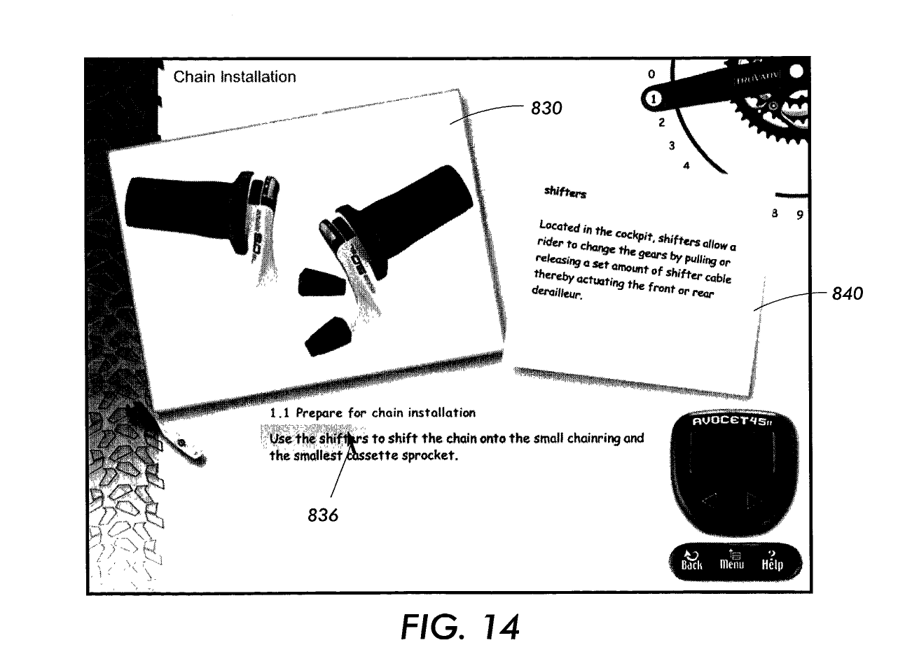

Referring first to the detail for step 1 (Prepare for chain installation), it will be appreciated that a user selecting the step in the upper right corner (placing the cursor over “1” and clicking the mouse, or selecting the text of the step, will be presented with a display screen as depicted in FIG. 13. Notably, the text indicated by reference numeral 646 in FIG. 11 is “blue” text that has a corresponding glossary entry maintained by the system. Thus, was a user to roll-over or select in regions 816, 818 or 820, the respective image for that component would automatically be displayed in the tilted image region 830. As an example, consider FIG. 14, where cursor 836 has been placed over the term “shifters,” causing an update of the scene wherein an image of a pair of shifters has been displayed in tilted image region 830. In addition, the scene in FIG. 14 has an additional component, glossary element 840, where a brief description of the term is displayed for the user's information and review.

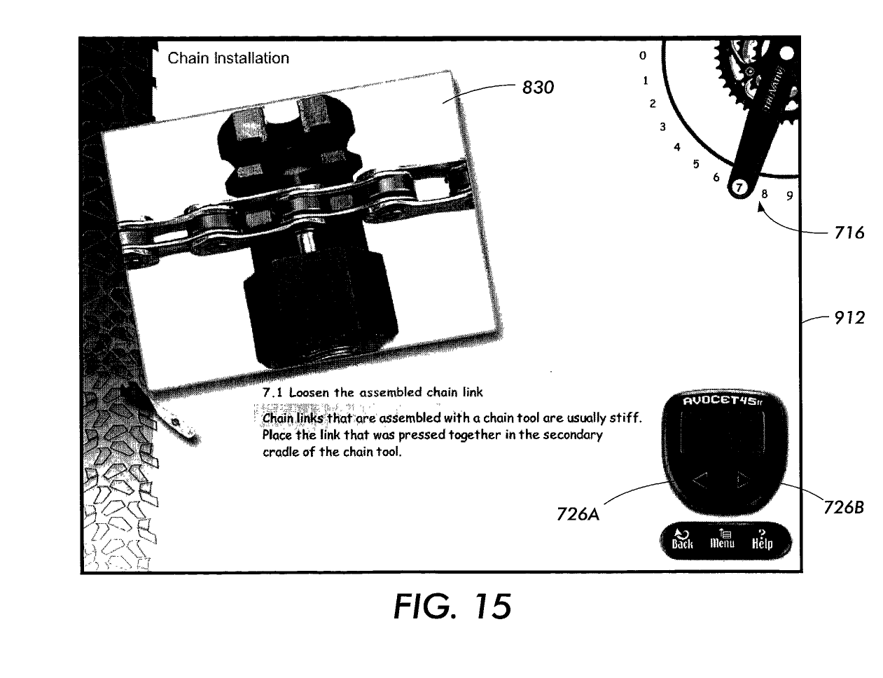

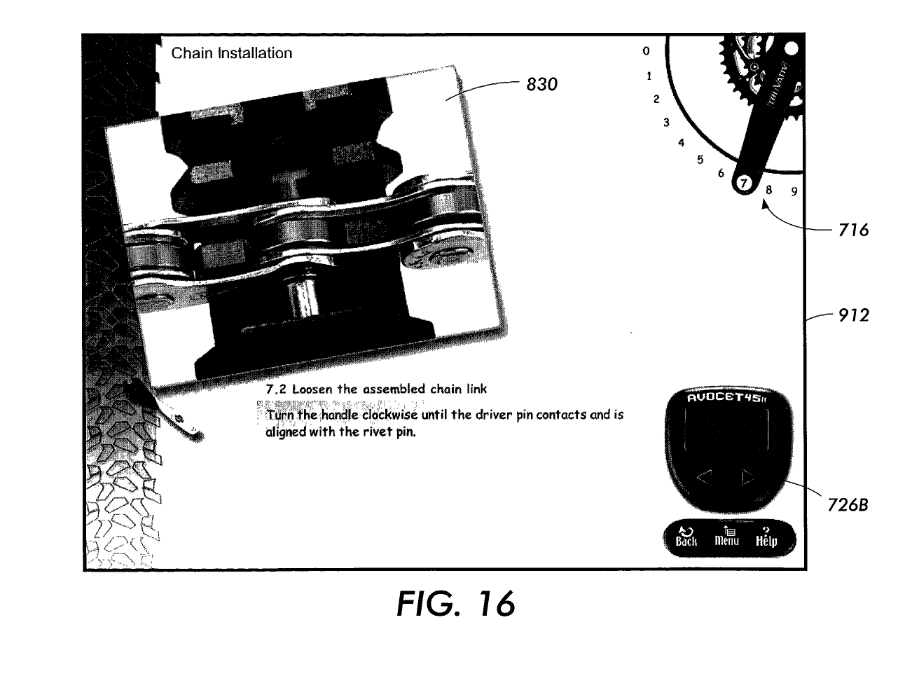

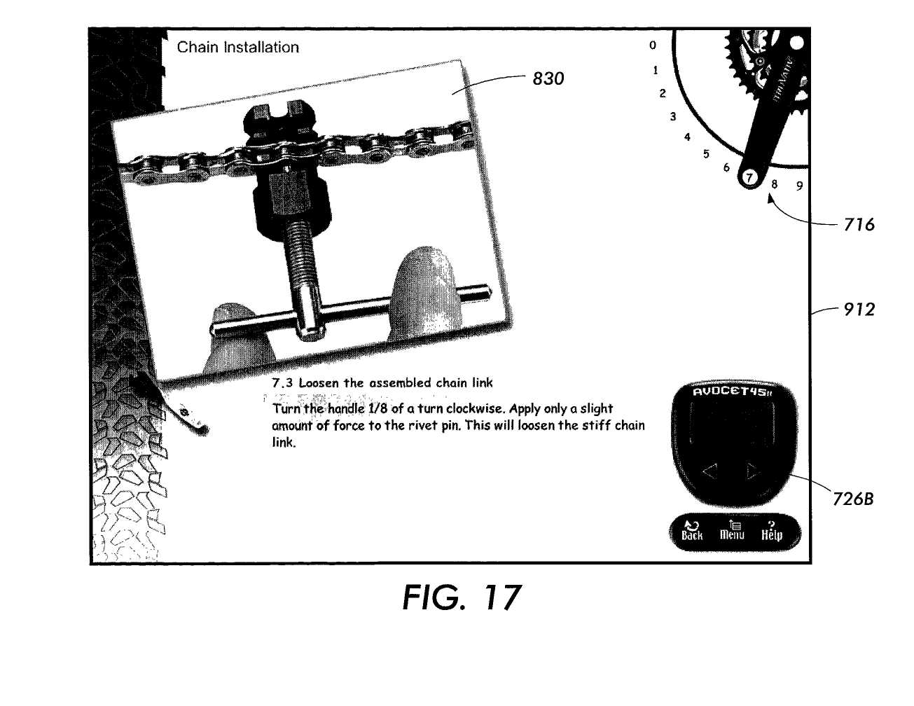

Referring next FIGS. 15-17, and to the example text for step 8 at the bottom of the display in FIG. 11 (which notable is automatically numbered by the system), the engine 50 of system 30 has automatically processed the tagged text of the DRCHIN.DOC document file to identify three sub-steps to step 7, delimited by page breaks (paragraphs) or similar means (FIGS. 15, 16 and 17 respectively). Each of the steps has an associated image linked to is displayed, so when the user moves a cursor to the “next” button 726 (as represented by the “>>” symbol), or to a previous sub-step via button 726A, the sub-steps of step 7 are displayed on the user interface. Again, this example illustrates just how easily the word-processor interface (e.g., FIG. 11) can be used to create or modify the hierarchical relationship of the display screens. Each screen or scene for a sub-step is identified by page-break delimited text falling under a step heading.

It will be appreciated from the above description that the text-based document used to create or dynamically alter the scenes displayed may also be used to determine the information (including textual and image data) to be displayed. Moreover, the user-selectable links on any particular page include, but are not limited to groups of links including:

a listing of tools required to complete a repair or maintenance procedure;

a component installation procedure;

a component removal procedure;

a component adjustment procedure, if any;

a component maintenance and lubrication guide;

a technical description and illustration of the component;

an emergency repair procedure and

a problem-solution guide.

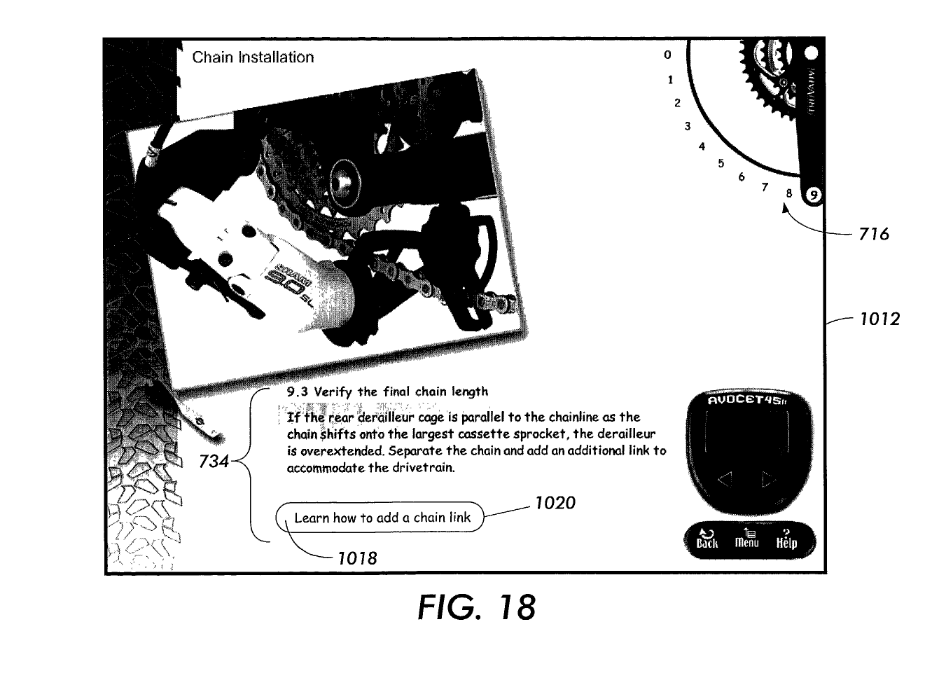

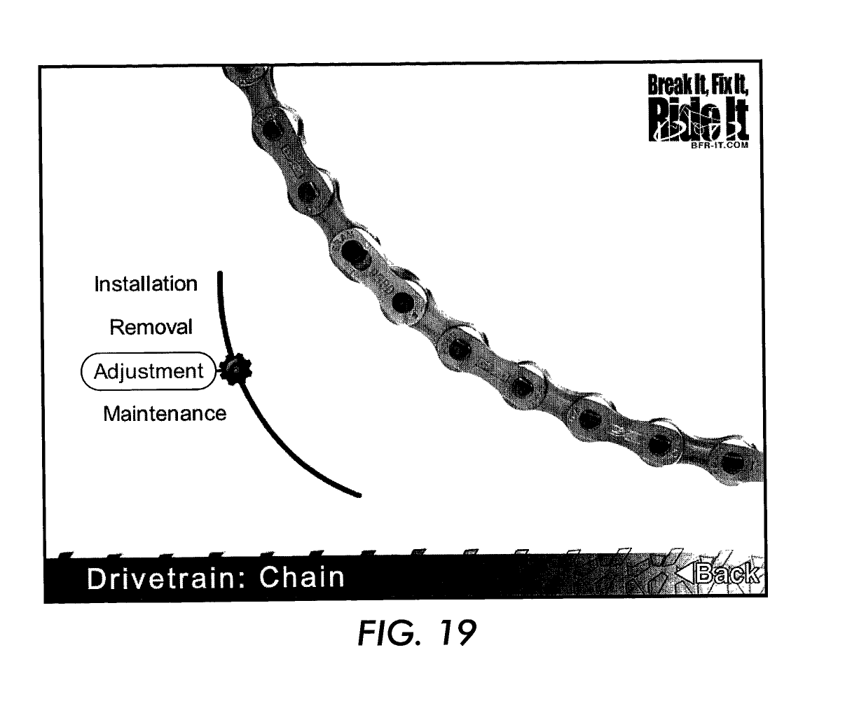

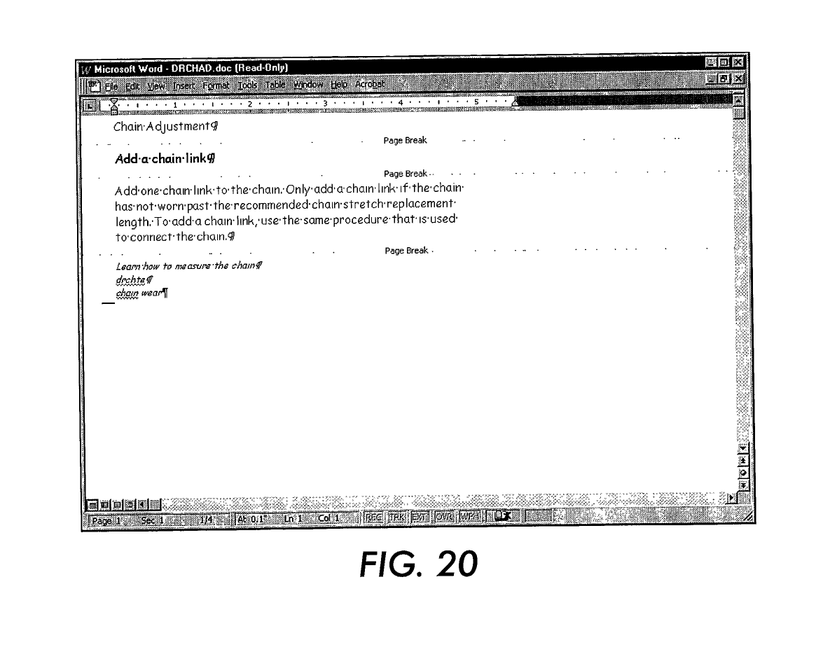

Referring now to FIGS. 18-19, in conjunction with CHAIN ADJUST SCREEN, an additional example of the creation of a user-interface using a text-based input document will be described in detail. In FIG. 18, there is depicted a final sub-step of the drive chain installation procedure described above. At the bottom of the text or step overview region 734, there is again depicted a live link to additional information, particularly information falling within the “Chain Adjustment” procedures of FIG. 19. Moreover, the details of the Chain Adjustment procedures are set forth in a text-based document, a portion of which is depicted in a word-processing interface in FIG. 1220 and the details of which are provided in CHAIN ADJUST SCREEN.

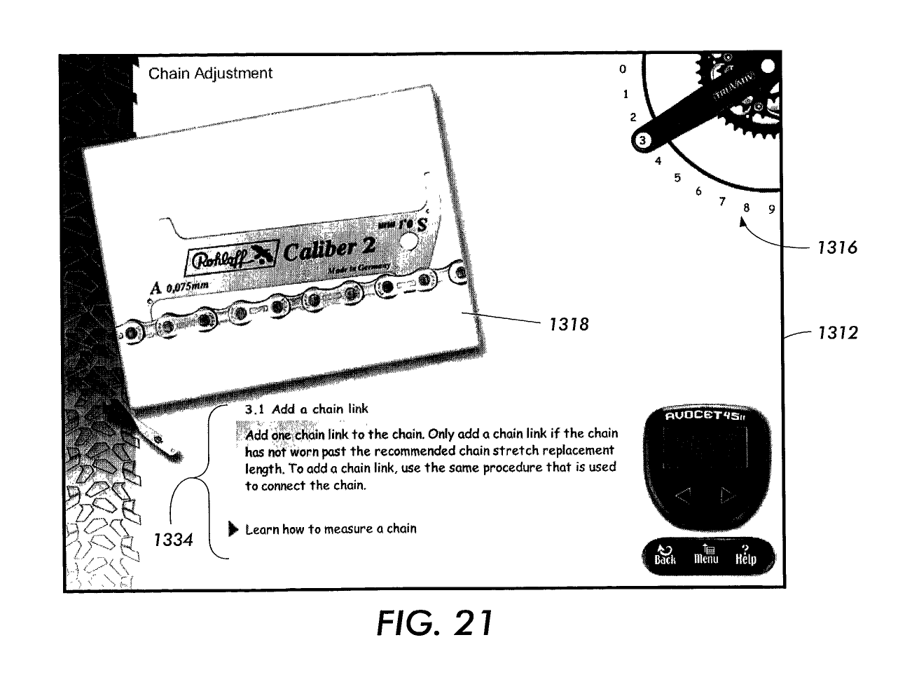

Referring to FIG. 18, when cursor 1018 is moved over linked text in region 1020, a user selection will result in a display change, where the user may be taken to the upper level menu of FIG. 19 (similar to FIG. 10), or alternatively directly to Chain adjustment step, particularly step 3, where a chain link is to be added. This level of “intelligence” may be added to the system by specifying a “go-to” link in the chain installation process. In other words, in FIG. 18 a user is presented with an image of an over-extended derailleur signifying a chain that needs to be lengthened. Selection of the “how to add a chain link” indicates that the user may wish to indeed lengthen the chain. Having anticipated this, the multi-media developer can use a go-to link in step 9.3, so that engine 50 can automatically insert such a link in the display, and allow direct access to the “Add a chain link” steps of the “Chain Adjustment” process depicted in the display of FIG. 21.

In accordance with yet another aspect of the present invention, it is contemplated that one or more manufacturers or component parts, replacement parts, tools, supplies may choose to sponsor such multi-media software. Because the multi-media software is directed to a target audience (e.g., mountain biking enthusiasts), it is believed that the multi-media program provides a readily available target market for advertisers. Accordingly, it is possible to identify, during the dynamic creation of a particular program or release of the software, particular manufacturer(s) whose products will be incorporated into the software, as images and possible as text information. In order to customize the system to create advertiser-specific output, it is contemplated that one or more advertiser identifiers may be associated with images in particular, but also with other aspects of the display interface (scenes, text, cast members, etc.). The present invention, and more particularly the image and text-based document interface contemplates the addition of an identifier of an advertiser or component manufacturer for each such file or document. Thus, when creating the multi-media output, engine 50 of FIG. 1 may be further modified to automatically associate, in response to such an identifier, a particular manufacturer's images or advertisements with the appropriate scenes to be displayed. Accordingly, the images, advertising materials or components of at least one manufacturer may be inserted into the user-interface in response to the manufacturer's agreement to pay compensation for such “advertisement.”

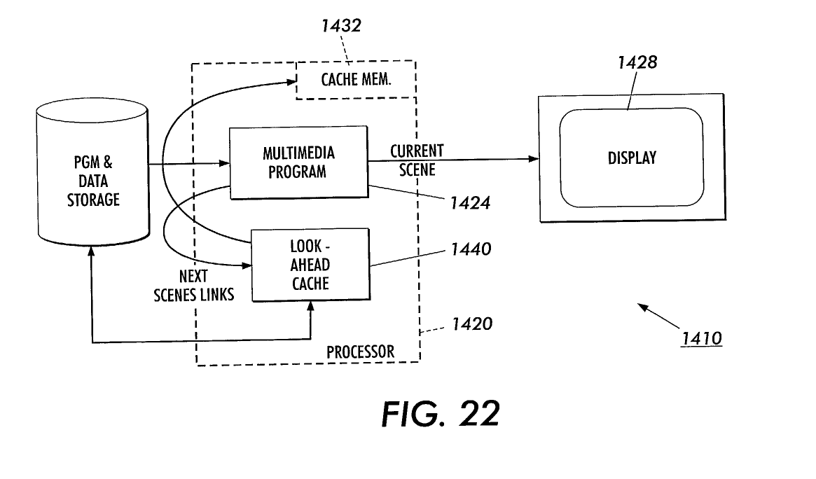

In a further embodiment of a multi-media program created in accordance with the present system, it is contemplated that such programs may implement a memory/cache control system such as that depicted in FIG. 22. In particular, such a system may include a workstation or similar computing device 1410 for operating a computer-based training resource such as those described above. Such a system would also include a processor 1420 running a macromedia software program 1424 for dynamically creating a plurality of pages for rendering on a display 1428. Also associated with processor is a memory cache 1432 (RAM or high-speed storage) and a look-ahead program module 1440, wherein loading of each linked element of a current display into the cache is initiated by the current display prior to a user selection, thereby improving the performance of the macromedia software.

As a further modification to the system 30 of FIG. 1, it is contemplated that images may require particular organization in the database, particularly during the development of the multimedia program 56. Recognizing that if you start from the actual image capture with a camera 34, a photographer capturing a 30 megabyte file likely passes that file on to a graphic artist who touches up the image to remove blemishes and corrects the color. At the same time, it is desirable to keep the raw image data. Recognizing that numerous images may be created from a single original file may exist, the relational, object-based database 36 of FIG. 1 is pre-configured to automatically assign a unique number to each digital image created by the camera 34. From there, the image is given its attributes, named, and a series of fields are entered to categorize that image.

Subsequently, when a graphic artist opens that image to work on it, another file is created with a unique identifier (the art editable file). When the graphic artist saves the art editable file in Photoshop, the action of saving the file acts as a trigger within the Oracle database to create an association with the newly saved file, thereby allowing the database to “know about” or track the new file and to relate it to an original image.

Because the database 36 is preferably a relational object-based system, it may also be possible to embed some or all of the functionality of engine 50 within the database—where it would be possible to match different images, and/or different blocks of text without having to rewrite it or store it redundantly. Accordingly, it is conceivable that embedding the engine within a database platform such as Oracle, would result in a repository data-driven system.

In recapitulation, the present invention is a method and apparatus for the development of complex multimedia programs, particularly those employed in educational and training software systems. The system employs a macromedia software engine that, using a word-processing document as an input, is capable of creating customizable macromedia output for display via a computer and through a network.

It is, therefore, apparent that there has been provided, in accordance with the present invention, a software development toolset, and more particularly a multimedia development system that may be employed to develop, with a word-processor, complex educational and training software systems. While this invention has been described in conjunction with preferred embodiments thereof, it is evident that many alternatives, modifications, and variations will be apparent to those skilled in the art. Accordingly, it is intended to embrace all such alternatives, modifications and variations that fall within the spirit and broad scope of the appended claims.

What is claimed is:

1. A computer-based bicycle maintenance resource, including:
a computer running a software program for dynamically creating a plurality of interrelated scenes for display;
a user-interface for displaying said scenes, wherein a plurality of the scenes represent hierarchical menu screens and where a main menu screen utilizes an image of a bicycle for the selection of menu items by a user rolling over the item and selecting the item; and
a user input device, where the user's selection of an item with the user input device will result in the display of the selected one of a plurality of modules and any components therein.

2. The system of claim 1, further comprising a user-selectable menu item for the display of a glossary of related terms associated with one or more components.

3. The system of claim 1, further comprising means for customizing the system in accordance with at least one user-specified preference.

4. The system of claim 3, wherein the user-specified preference is the make and model of bicycle.

5. The system of claim 1, wherein the system is implemented as a stand-alone software system running on a remote computer.

6. The system of claim 1, wherein the system is implemented using a client-server model, where a remote computer accesses the system via a network.

7. The system of claim 1, further comprising a step-by-step instruction sequence, with associated illustrations, for a plurality of diagnostic and maintenance procedures.

8. The system of claim 1, wherein each component menu screen includes user-selectable links to at least one of the group of links consisting of:
a listing of tools required to complete a procedure;
a component installation procedure;
a component removal procedure;
a component adjustment procedure;
a component maintenance and lubrication guide;
a technical description and illustration of the component;
an emergency repair procedure; and
problem-solution guidelines.

9. The system of claim 1, wherein at least one scene of the user-interface is created by the software program in response to input from a tag-based input file.

10. The system of claim 9, wherein the tag-based input file is a native word processing file.

11. A computer-based training resource, including:
a computer running a software program for dynamically creating a plurality of scenes for display;
a user-interface for displaying said scenes, wherein a plurality of the scenes represent a plurality of menu screens and where a main menu screen utilizes an image to which the training is directed and lower level menu screens depict particular components or portions of the image; and
wherein the image is selected from a database of images, where each of said images includes an identifier of the manufacturer of an item depicted in the image, wherein the images may be inserted into the user-interface in accordance with a pre-selected identifier.

12. The computer-based training resource of claim 11, further including:
a cache, associated with said computer, said cache comprising:
a look-ahead module, wherein loading of each linked element of a current display into the cache is initiated by the current display prior to a user selection, thereby improving the performance of the software.

13. A computer-based media development resource, including:
a computer running a software program for dynamically creating a plurality of scenes for display;
a user-interface for displaying said scenes, wherein a plurality of the scenes represent a plurality of menu screens and where a main menu screen utilizes an image with which the resource is related, and lower level menu screens depict particular components or portions of said image; and
a database of sub-images, each depicting elements of the image, wherein each of said sub-images includes a unique identifier to control its dynamic display in the user-interface.

14. A method for the dynamic display of computer-generated media, including the steps of:
creating a text-based document to direct the display of the computer-generated media;
parsing the text-based document to determine relationships between elements of the computer-generated media; and
generating, in response to step of parsing the text-based document, a software program incorporating graphical and textual information defined by the text-based document.

15. The method of claim 14, further comprising the steps of:
running, on a computer the generated software program, for dynamically creating a plurality of scenes for display to a user;
interacting with a user-interface associated with the computer, for displaying said scenes, wherein a plurality of the scenes represent a plurality of menu screens and where a main menu screen utilizes an image with which the resource is related, and lower level menu screens depict particular components or portions of said image; and
a database of sub-images, each depicting elements of the image, wherein each of said sub-images includes a unique identifier to control its insertion into the user-interface.

16. The method of claim 15, wherein the image and database of sub-images incorporate high-resolution image data further including the steps of:
compressing a plurality of image files to less than about fifteen percent of their original size;
hosting the plurality of compressed images as a plurality of video elements;
associating at least one of said video elements as a cast member to be depicted in a scene of the system, wherein the step of associating at least one of said video elements as a cast member does not result in an expansion of the amount of data necessary to represent the image file.

17. The method of claim 14, further comprising the step of displaying a user-selectable menu item for the display of a glossary of related terms associated with one or more components, wherein the text-based document determines those terms to be included within the glossary of related terms.

18. The method of claim 15, further comprising the step of customizing the system in accordance with at least one user-specified preference.

19. The method of claim 14, wherein the step of creating a text-based document to direct the display of the computer-generated media further comprises including within the text-based document a step-by-step instruction sequence for a plurality of maintenance procedures.

20. The method of claim 19, wherein the plurality of maintenance procedures are related to the maintenance of a bicycle.

21. The method of claim 19, wherein the step of creating a text-based document to direct the display of the computer-generated media includes inserting a user-selectable link selected from the group of links consisting of:
a listing of tools required to complete a procedure;
a component installation procedure;
a component removal procedure;
a component adjustment procedure;
a component maintenance and lubrication guide;
a technical description and illustration of the component;
an emergency repair procedure; and
problem-solution guidelines.
